(19) United States
(12) Patent Application Publication
(10) Pub. No.: US 2025/0042761 A1
(43) Pub. Date: Feb. 6, 2025

(54) POLYOXOMETALATES FOR THE PREPARATION OF OPTICAL METAL OXIDE LAYERS

(71) Applicant: MERCK PATENT GMBH, DARMSTADT (DE)

(72) Inventors: OLIVER DOLL, DIETZENBACH (DE); HAGAI ARBELL, MEVASERET ZION (IL); HENNING SEIM, DARMSTADT (DE)

(21) Appl. No.: 18/920,739

(22) Filed: Oct. 18, 2024

Related U.S. Application Data
(63) Continuation of application No. PCT/EP2023/058907, filed on Apr. 5, 2023.

(30) Foreign Application Priority Data
Apr. 8, 2022 (EP) 22167371.8

(51) Int. Cl. C01G 33/00; G02B 5/18; G02B 27/01

(52) U.S. Cl. CPC C01G 33/006; G02B 5/18; G02B 27/0172; C01P 2002/89; C01P 2006/60

(57) ABSTRACT

A polyoxometalate compound with a polyoxometalate cluster includes Group 5 elements. A formulation is provided that includes the polyoxometalate compound, and a method is provided for preparing an optical metal oxide layer using the formulation and polyoxometalate compound. The obtained optical metal oxide layers are particularly suitable for applications in optical devices such as, for example, in augmented reality (AR) and/or virtual reality (VR) devices.

### CROSS-REFERENCE TO RELATED APPLICATIONS

This application is a Continuation under 35 USC § 111 (a) of International Patent Application No. PCT/EP2023/058907, filed Apr. 5, 2023, which claims priority to EP patent application Ser. No. 22/167,371.8, filed Apr. 8, 2022, the entire contents of each is incorporated herein by reference in their entirety.

### FIELD OF THE INVENTION

The present invention relates to a polyoxometalate compound, a formulation and a method for preparing an optical metal oxide layer.

The polyoxometalate compound according to the present invention contains a polyoxometalate cluster comprising two or three Group 5 elements. The formulation according to the present invention comprises a polyoxometalate compound and one or more formulation media. The method for preparing an optical metal oxide layer according to the present invention involves applying said formulation to a surface of a substrate; and converting it to an optical metal oxide layer. The obtained optical metal oxide layers are particularly suitable for optical applications and may be used in optical devices such as, for example, in diffractive gratings for augmented reality (AR) and/or virtual reality (VR) devices. The optical metal oxide layers show (a) favorable optical properties such as high refractive index (RI) of >1.7, preferably >2.0, at wavelengths of ≤520 nm, low absorption, and low degree of haze formation; (b) favorable mechanical properties such as low shrinkage, (c) favorable coating properties such as dense layer and flat surface structure; and (d) favorable filling properties such as homogeneous filling of topographical features on patterned substrates.

The embodiments of the present invention allow the preparation of optical metal oxide layers on the surface of both patterned and non-patterned substrates. The metal oxide layer may form various structures such as, for example, layers covering a surface of a non-patterned substrate and/or fillings covering topographical features such as e.g. gaps on the surface of a patterned substrate, thereby providing highly refractive optical structures. In particular, the embodiments of the present invention allow the preparation of advanced optical gap filling with low overburden, thus enabling an easy and cost efficient mass production of complex optical devices by avoiding typical problems occurring when layer deposition or gap filling is performed by physical vapor deposition (PVD) or chemical vapor deposition (CVD) techniques such as, for example, incomplete or excessive gap filling due to unfavourable deposition and layer growth characteristics such as, for example, decreased or increased deposition or growth rates at corners and edges.

The embodiments of the present invention are particularly suitable for the preparation of optical metal oxide layers having high refractive index for optical devices such as, for example, for diffractive gratings in AR and/or VR devices.

Finally, the present invention provides an optical device, preferably an AR and/or VR device, comprising an optical metal oxide layer, which is obtainable by the method according to the present invention or which is prepared by using the formulation according to the present invention.

### BACKGROUND OF THE INVENTION

Leading edge optical devices typically include optical gratings made from composite materials having a substrate as a support and complex and interlaced patterns thereon, the patterns being made up of different layers or stacks of layers. Usually, the creation of such complex and interlaced patterns demands for structuring processes, which become increasingly challenging with decreasing size of structural dimensions to be prepared.

In addition to a wide range of possible uses in various fields of application, such as in spectrometers or in optical storage systems (CD, DVD, etc.), diffractive gratings are the core components of so-called XR devices, mostly glasses. In this context, R stands for the term reality and X denotes different attributes such as, for example, virtual, augmented, mixed and so forth. Hence, diffractive gratings form part of the core of the so-called optical engine in XR devices, specifically in augmented reality and mixed reality glasses. Virtual reality glasses, when built as a head mounted display, are often composed of a conventional liquid crystal (LC) organic light emitting diode (OLED) display being embedded in the device, and thus do not necessarily require diffractive gratings. In contrast, augmented and mixed reality glasses are designed that way to enable consumers to obtain visual impressions of their environment, at its best as if they would not wear any glasses at all. However, they also make it possible to provide and serve digital information and to also project it into the field of vision of individuals. Additional digital information is gathered from recognizing and analyzing the environment, the individual inspects or takes a look currently at. In order to convey and project supporting digital information into the eyes of an individual, the augmented or mixed reality glasses are equipped with an information supply unit, which is coupled to an optical waveguide system that transports the optically coded supporting information through it directly to the lens of the glasses. Here, the information passes a diffractive grating which couples the incident light into the lens and splits it according to its angular information and its spectral bands by diffraction. After incoupling of the light, the lens serves as waveguide enabling transport of the light to and into the pupil of an individual. The location of light incoupling is independent of any preferred position and thus of the implication of technical needs. The direction of traversal of light within the lenses is determined by the diffractive grating diffracting or splitting the light. At certain positions in the lens, a second and a third diffractive grating serves for changing the direction of light traversal and thereby enforcing the light to be projected into pupil of the user. The light traversal in the glasses is accomplished by total internal reflection (TIR) of the light, thus bouncing several times between the glass interfaces until reaching another diffractive grating, which changes the internal TIR direction of the light (see FIG. 2). The second and third grating are geometrically aligned in different directions with respect to the first and incoupling grating, e. g. by a certain angular distortion of the longitudinal axis, thus allowing to change the direction of propagation of totally internally reflected light. Needless to say, the lens itself or the material of which lenses are made of shall not be absorbing. Otherwise, the supportive information never reaches the pupil of the user or only with strongly depleted light intensity. The process works regardless of the use of reflection or transmission gratings. Usually, the lenses are equipped with both types of gratings to properly guide the light. It should also be mentioned that there are differences in the optical performance of reflection and transmission gratings, which, however, are of no further interest in the context of the current invention. The basic structure of the gratings is very similar, which is more important at this point.

Nevertheless, there are different designs and structures such as surface relief (SR) or volume phase holographic (VPH) gratings to achieve waveguide. Both types are very similar in appearance. In the simplest case, the gratings are somehow mounted onto the surface of a waveguiding material, here the lens. The grating itself is composed of an array of fine structures, mostly trenches of a first material type Material 01 with a refractive index RI 01, however, not limited thereto. The geometrical shape of the trenches may be manifold, from rectangular, over V-shaped trenches, U-shaped and there like. The width, including structures with different widths, the geometrical form of the trenches, their pitch as well as their depth, including different depths, are specially designed to influence the diffraction pattern of the incident light to be diffracted.

In case of SR gratings (SRGs), the trenches or structures of a first material type (Material 01) having a refractive index (RI 01) are filled by a second material type (Material 02) having a refractive index (RI 02), wherein RI 02 is incrementally different from RI 01 (see FIGS. 1 and 3). For the sake of completeness, it should be mentioned that Material 01 or Material 02 may be composed of a stack of structured layers, each containing a different material composition with different refractive index, stacked on top of each other, thereby forming Material 01 or Material 02 having an effective or graded refractive index RI 01 or RI 02, respectively. Incidentally, the (effective or graded) refractive indices RI 01 and RI 02 depend on the refractive index of the waveguide or the lens from which the glasses are made of. If a glass lens with high refractive index (n03>1.46) is used, the (effective or graded) refractive indices of Material 01 and Material 02 are considered to be higher than that of the lens itself, whereby a RI value of 2.0 can be reached and exceeded. High performance gratings, especially those of SR-type, may be manufactured using standard lithography and deposition techniques known from micro-fabrication such as, for example, the manufacturing of integrated circuits.

Such standard techniques typically include physical vapor deposition (PVD) or chemical vapor deposition (CVD) processes and often suffer from incomplete gap filling due to unfavourable deposition and/or layer growth deposition properties including increased deposition and/or growth rates at corners and edges. Such incomplete gap filling results in the formation of voids within the structures to be filled by the PVD- and CVD-materials. In addition to the formation of voids, the surface of the substrate is covered by a PVD and/or CVD layer that is almost as thick as the maximum depth of the deepest structure to be filled by the deposited gap filling material (see FIGS. 4 and 5). In some applications, however, it may be necessary to expose the surface of the substrate so that it is available for further processing. As a consequence, undesired overburden layers from PVD or CVD need to be removed, for example by chemical mechanical planarization (CMP) without harming the original substrate surface underneath. Although CMP is very well established in the process of manufacturing integrated circuits, CMP is a time consuming and costly process and can be seen as a potential economic drawback for mass production of leading-edge optical devices, particularly the mass production of diffractive gratings. It would therefore be desirable to have a solution for an advanced and cost-efficient manufacturing of optical gratings where gap filling does not require CMP (see FIG. 6).

The present invention addresses various disadvantages of the technologies for preparing optical gratings for leading edge optical devices as described above. The focus here is on improved optical properties, improved mechanical properties, improved coating properties and improved filling properties. Furthermore, are of interest.

### OBJECT OF THE INVENTION

It is an object of the present invention to provide a polyoxometalate compound, a formulation and a method for preparing optical metal oxide layers, wherein said metal oxide layers are particularly suitable for optical applications and may be used in optical devices such as, for example, in diffractive gratings for AR and/or VR devices. The obtained optical metal oxide layers show (a) favorable optical properties such as high refractive index (RI) of >1.7, preferably >2.0, at wavelengths of ≤520 nm, low absorption, and low degree of haze formation; (b) favorable mechanical properties such as low shrinkage, (c) favorable coating properties such as dense layer and flat surface structure; and (d) favorable filling properties such as homogeneous filling of topographical features on patterned substrates.

Moreover, it is an object of the present invention to provide a polyoxometalate compound, a formulation and a method allowing an easy and cost-efficient preparation of optical metal oxide layers.

It is a further object of the present invention to enable preparation of optical metal oxide layers on the surface of both patterned and non-patterned substrates. The metal oxide layers may form various structures such as, for example, layers covering a surface of a non-patterned substrate and/or fillings covering topographical features such as, for example, gaps on the surface of a patterned substrate, thereby providing highly refractive optical structures.

Hence, it is an object of the present invention to provide a polyoxometalate compound, a formulation and a method for preparing an optical metal oxide layer, which allow obtaining advanced optical gap filling with low overburden, thus enabling an easy and cost-efficient mass production of complex optical devices.

It is a further object of the present invention to provide a polyoxometalate compound, a formulation and a method for preparing an optical metal oxide layer, which avoid typical problems occurring when layer deposition or gap filling is performed by PVD or CVD techniques such as, for example, incomplete or excessive gap filling due to unfavourable deposition and layer growth characteristics such as, for example, decreased or increased deposition or growth rates at corners and edges.

It is an object of the present invention that the polyoxometalate compound and formulation are particularly suitable for the preparation of optical metal oxide layers having high refractive index for optical devices such as, for example, for diffractive gratings in AR and/or VR devices.

Finally, it is an object of the present invention to provide an optical device, preferably an AR and/or VR device, comprising an optical metal oxide layer, which is obtainable by the method according to the present invention or which is prepared by using the formulation according to the present invention, and thereby shows the above-mentioned beneficial effects.

### SUMMARY OF THE INVENTION

The present inventors surprisingly found that the above objects are achieved by the following embodiments:

A polyoxometalate compound containing a polyoxometalate cluster, wherein the polyoxometalate cluster comprises two or three Group 5 elements, preferably selected from V, Nb and Ta.

A formulation for preparing an optical metal oxide layer, wherein said formulation comprises:
(i) a polyoxometalate compound containing a polyoxometalate cluster, wherein the polyoxometalate cluster comprises one, two or three Group 5 elements, preferably selected from V, Nb and Ta; and
(ii) one or more formulation media.

A method for preparing an optical metal oxide layer comprising the following steps (a) to (c):
(a) providing a formulation according to the present invention;
(b) applying the formulation to a surface of a substrate; and
(c) converting the formulation on the surface of the substrate to an optical metal oxide layer.

Finally, an optical device is provided comprising an optical metal oxide layer, which is obtainable or obtained by the method according to the present invention or which is prepared by using the formulation according to the present invention, wherein the optical device is preferably an augmented reality (AR) and/or virtual reality (VR) device.

Preferred embodiments of the present invention are described hereinafter and in the dependent claims.

### BRIEF DESCRIPTION OF THE FIGURES

FIG. 1: Schematic cross-sectional view of a SR grating with a Material 01 and a Material 02, wherein the refractive index IR 01 of Material 01 is incrementally different to the refractive index IR 02 of Material 02.

FIG. 2: Schematic cross-sectional view of a SR grating enabling light diffraction (transmissive case) including propagation of diffracted light within waveguide (e.g. lens) by total internal reflection.

FIG. 3: Schematic cross-sectional view of a SR grating providing gaps (trenches) to be filled with a high refractive index material (Material 02), wherein the refractive index of Material 02 is incrementally different form the refractive index of Material 01 flanking the gaps (trenches).

FIG. 4: Schematic representation of PVD- or CVD-mediated gap filling process and removal of undesired overburden.

FIG. 5: Schematic representation of PVD- or CVD-mediated gap filling process creating and leaving voids within gaps and deposited layers.

FIG. 6: Schematic representation of gap filling process using formulations containing inventive metal complex or formulations thereof being converted to metal oxides.

FIG. 7: Mass spectrogram of compound from Example 2 (tetrabutylammonium polyniobate). Peak at m/z 2831.56 Da indicates hexakis (tetrabutylammonium) decaniobate occurring as ion pair or cluster ion. The peak at m/z 2590.29 Da indicates a cluster ion of hexakis (tetrabutylammonium) decaniobate accompanied by the loss of one tetrabutylammonium ligand.

FIG. 8: Refractive index and absorption index of layers obtained from material of Example 2 after coating on quartz wafers and baking at 300° C., 400° C. and 500° C., respectively, for 60 minutes as described in Example 4.

FIG. 9: SEM cross-sectional view of an array of trenches having a depth of 450 nm, an opening width of 47 nm at half depth and a pitch of 450 nm as illustrative example of a substrate comprising topographical features on its surface (see Example 5).

FIG. 10: SEM cross-sectional view of an array of trenches after layer coating and pre-baking as described in Example 5 (the thickness of the top layer covering the trenches was 916 nm).

FIG. 11: SEM cross-sectional view of an array of trenches after layer coating, followed by pre-baking and baking as described in Example 5 (the thickness of the top layer covering the trenches was 748 nm).

FIG. 12: Refractive index and absorption index of layers obtained from material of Example 2 doped with lanthanum oxide precursor after coating on quartz wafers and baking at 300° C., 400° C. and 500° C., respectively, for 60 minutes as described in Example 6.

FIG. 13: Refractive index and absorption index of layers obtained from material of Example 2 doped with lanthanum oxide precursor after coating on quartz wafers and baking at 300° C., 400° C. and 500° C., respectively, for 60 minutes as described in Example 7.

FIG. 14: Mass spectrogram of compound from Example 8 (tetrabutylammonium polytantalate). Peak at m/z 3710.9 Da indicates hexakis (tetrabutylammonium) decatantalate occurring as ion pair or cluster ion. Ions at m/z 3952.1 Da as well as 3469.9 Da may indicate cluster ions of hexakis (tetrabutylammonium) decatantalate with either addition or subtraction of a tetrabutylammonium ion, respectively.

FIG. 15: SEM cross-sectional view of an array of trenches after layer coating and pre-baking as described in Example 10 (the thickness of the top layer covering the trenches was 614 nm).

FIG. 16: SEM cross-sectional view of an array of trenches after layer coating, followed by pre-baking, temperature ramping and finally baking as described in Example 10 (the thickness of the top layer covering the trenches was 240 nm).

FIG. 17: Mass spectrogram of compound from Example 11 (tetrabutylammonium poly (niobate-tantalate)). Attribution of peaks is shown in Table 6.

FIG. 18: Mass spectrogram of compound from Example 13 (tetrabutylammonium poly (niobate-titanate). Further discussion is provided in Example 13.

FIG. 19: Mass spectrogram of compound from Example 13 (tetrabutylammonium poly (niobate-titanate). Further discussion is provided in Example 13.

FIG. 20: Mass spectrogram of compound from Example 17 (tetrabutylammonium poly (niobate-vanadate). Attribution of peaks is shown in Table 10.

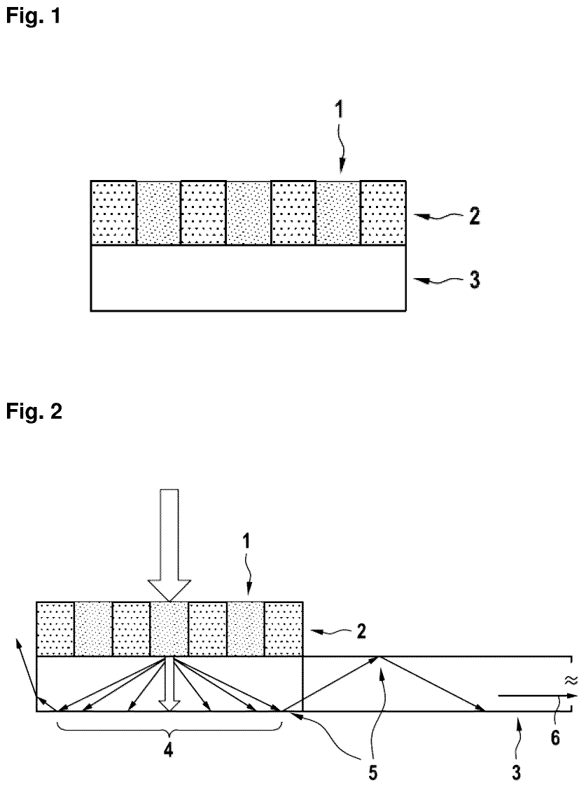

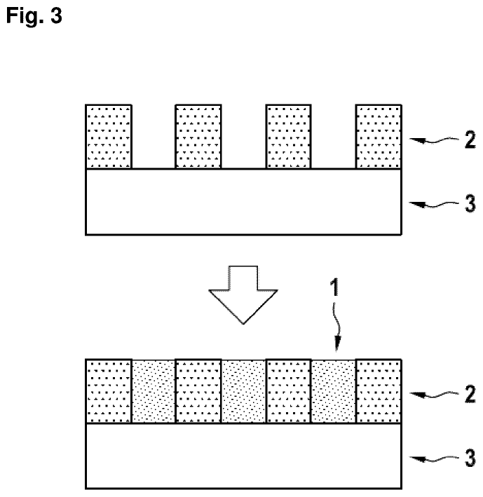

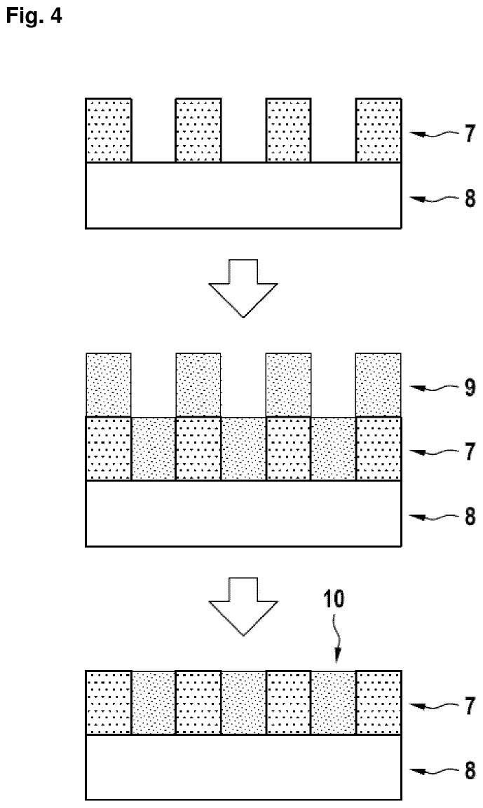

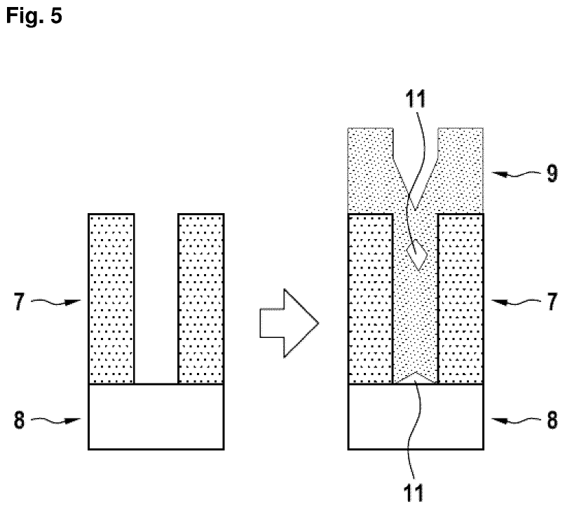

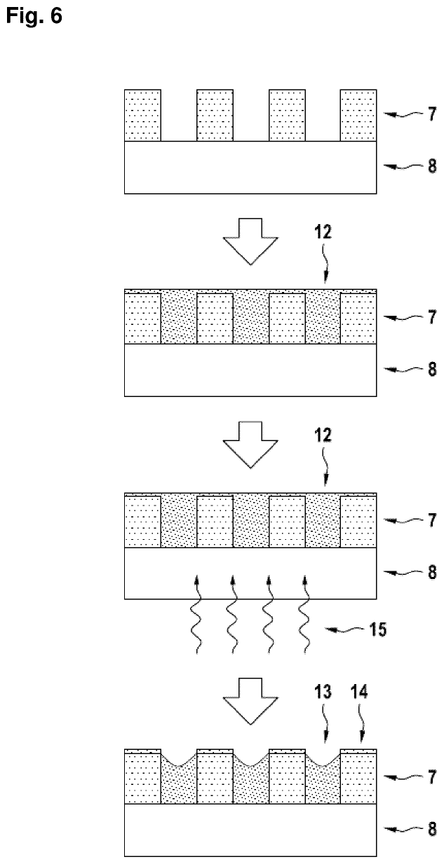

### DETAILED DESCRIPTION

### Definitions

The term “polyoxometalate” as used herein, refers to a polyatomic ion, usually an anion, that consists of three or more transition metal oxyanions linked together by shared oxygen atoms to form closed 3-dimensional frameworks, also referred to as clusters. The metal atoms are usually Group 6 (Mo, W) or less commonly Group 5 (V, Nb, Ta) or Group 4 (Ti, Zr, Hf) transition metals in their high oxidation states. They are usually colorless or orange, diamagnetic anions. Two broad families are recognized, isopolymetalates, composed of only one kind of metal and oxide, and heteropolymetalates, composed of one metal, oxide and a main group oxyanion (e.g. phosphate, silicate, etc.). To balance the charge, polyoxometalate compounds may comprise one or more different cations (e.g. alkali metal cations, alkaline earth metal cations, ammonium cations, etc.).

Group 5 metal polyoxometalates are described in:
(1) A. Llordes et al., Polyoxometalates and colloidal nanocrystals as building blocks for metal oxide nanocomposite films, J. Mater. Chem., 2011, 21, 11631-11638.
(2) W. G. Klemperer et al., An 170 NMR Study of Hydrolyzed Nb (V) in Weakly Acidic and Basic Aqueous Solution, Eur. J. Inorg. Chem., 2013, 1762-1771.

In the context of the present invention, the term “formulation medium” or the plural term “formulation media” as used herein, denote one or more compounds serving as a solvent, suspending agent, carrier and/or matrix for the polyoxometalate compound and any other component included in the formulation. Formulation media are generally inert compounds that do not react with said polyoxometalate compounds and said other components. Formulation media may be liquid compounds, solid compounds or mixtures thereof. Typically, formulation media are organic compounds.

The term “surfactant” as used herein, refers to an additive that reduces the surface tension of a given formulation.

The term “wetting and dispersion agent” as used herein, refers to an additive hat increases the spreading and penetrating properties of a given formulation. In this way, the tendency of the molecules to adhere to each other is reduced.

The term “adhesion promoter” as used herein, refers to an additive that increases the adhesion of a given formulation.

The term “polymer matrix” as used herein, refers to an additive that acts as a macromolecular matrix for one or more components of a given formulation.

The term “optical device” as used herein, relates to a device containing one or more optical components for forming a light beam including, but not limited to, gratings, lenses, prisms, mirrors, optical windows, filters, polarizing optics, UV and IR optics, and optical coatings. Preferred optical devices in the context of the present invention are augmented reality (AR) glasses and/or virtual reality (VR) glasses.

### PREFERRED EMBODIMENTS

### Polyoxometalate Compound

The present invention relates to a polyoxometalate compound containing a polyoxometalate cluster, wherein the polyoxometalate cluster comprises two or three Group 5 elements, preferably selected from V, Nb and Ta. The Group 5 elements comprised in the polyoxometalate cluster of the polyoxometalate compound are different from each other. It is preferred that the polyoxometalate cluster contained in the polyoxometalate compound comprises two Group 5 elements selected from V, Nb and Ta.

In a preferred embodiment of the present invention, the polyoxometalate cluster contained in the polyoxometalate compound further comprises one or more Group 4 elements, preferably selected from Ti, Zr and Hf. In case more Group 4 elements are comprised in the polyoxometalate cluster, the Group 4 elements are different from each other. In a more preferred embodiment of the present invention, the polyoxometalate cluster contained in the polyoxometalate compound further comprises Ti.

In a preferred embodiment of the present invention, the polyoxometalate cluster is selected from poly (vanadate-niobates), poly (vanadate-tantalates), poly (niobate-tantalates), poly (vanadate-niobate-titanates), poly (vanadate-tantalate-titanates), poly (niobate-tantalate-titanates), poly (vanadate-niobate-zirconates), poly (vanadate-tantalate-zirconates), poly (niobate-tantalate-zirconates), poly (vanadate-niobate-hafniates), poly (vanadate-tantalate-hafniates), poly (niobate-tantalate-hafniates), poly (vanadate-niobate-tantalate-titanates), poly (vanadate-niobate-tantalate-zirconates), and poly (vanadate-niobate-tantalate-hafniates).

Preferred poly (vanadate-niobates) are tetra (vanadate-niobates), hexa (vanadate-niobates), deca (vanadate-niobates) and dodeca (vanadate-niobates). More preferred poly (vanadate-niobates) are hexa (vanadate-niobates) and deca (vanadate-niobates).

Preferred poly (vanadate-tantalates) are tetra (vanadate-tantalates), hexa (vanadate-tantalates), deca (vanadate-tantalates) and dodeca (vanadate-tantalates). More preferred poly (vanadate-tantalates) are hexa (vanadate-tantalates) and deca (vanadate-tantalates).

Preferred poly (niobate-tantalates) are tetra (niobate-tantalates), hexa (niobate-tantalates), deca (niobate-tantalates) and dodeca (niobate-tantalates). More preferred poly (niobate-tantalates) are hexa (niobate-tantalates) and deca (niobate-tantalates).

In a preferred embodiment of the present invention, the polyoxometalate cluster contained in the polyoxometalate compound is represented by Formula (1):

[M¹ₓ₁M²ₓ₂O_{y}]^{m} Formula (1)

wherein:
M¹ is a mixture of two or three Group 5 elements, preferably selected from V, Nb and Ta, wherein preferably M¹ is a mixture of V and Nb, V and Ta, Nb and Ta, or V, Nb and Ta;
M² is one or a mixture of more Group 4 elements, preferably selected from Ti, Zr and Hf, wherein preferably M² is Ti, Zr or Hf, more preferably Ti;
O is oxygen;
x1 is an integer from 3 to 40, preferably 4 to 32, more preferably 6 to 24, even more preferably 6 to 12, and most preferably 10;
x2 is an integer from 0 to 40, preferably 0 to 32, more preferably 0 to 24, even more preferably 1 to 12, and most preferably 1, 2, 3, 4, 5, 6, 7, 8, 9 or 10;
wherein preferably x1+x2=3 to 40, preferably 4 to 32, more preferably 6 to 24, even more preferably 6 to 12, and most preferably 10;
y is an integer from 8 to 160, preferably 12 to 120, more preferably 22 to 96, even more preferably 28 to 72, and most preferably 28 to 40; and
m represents the total charge of the polyoxometalate cluster, wherein preferably m=S1*x1+S2*x2−2*y, wherein S1 represents the value of the oxidation state of M¹, preferably S1 is 2, 3, 4, or 5, more preferably S1 is 5, and S2 represents the value of oxidation state of M², preferably S2 is 2, 3 or 4, more preferably S2 is 4.

In a more preferred embodiment of the present invention, the polyoxometalate cluster contained in the polyoxometalate compound is represented by Formula (1):

[M¹ₓ₁M²ₓ₂O_{y}]^{m} Formula (1)

wherein:
M¹ is a mixture of V and Nb, V and Ta, Nb and Ta, or V, Nb and Ta;
M² is Ti, Zr or Hf, preferably Ti;
O is oxygen;
x1 is an integer from 3 to 40, preferably 4 to 32, more preferably 6 to 24, even more preferably 6 to 12, and most preferably 10;
x2 is an integer from 0 to 40, preferably 0 to 32, more preferably 0 to 24, even more preferably 1 to 12, and most preferably 1, 2, 3, 4, 5, 6, 7, 8, 9 or 10;
wherein x1+x2=3 to 40, preferably 4 to 32, more preferably 6 to 24, even more preferably 6 to 12, and most preferably 10;
y is an integer from 8 to 160, preferably 12 to 120, more preferably 22 to 96, even more preferably 28 to 72, and most preferably 28 to 40; and
m represents the total charge of the polyoxometalate cluster, wherein
m=S1*x1+S2*x2−2*y, wherein S1 is 5, and S2 is 4.

In a most preferred embodiment of the present invention, the polyoxometalate cluster contained in the polyoxometalate compound is represented by Formula (1):

[M¹ₓ₁M²ₓ₂O_{y}]^{m} Formula (1)

wherein:
M¹ is a mixture of V and Nb, V and Ta, Nb and Ta, or V, Nb and Ta;
M² is Ti;
O is oxygen;
x1 is an integer from 4 to 32, preferably 6 to 24, more preferably 6 to 12, and most preferably 10;
x2 is an integer from 0 to 32, preferably 0 to 24, more preferably 1 to 12, and most preferably 1, 2, 3, 4, 5, 6, 7, 8, 9 or 10;
wherein x1+x2=4 to 32, preferably 6 to 24, more preferably 6 to 12, and most preferably 10;
y is an integer from 12 to 120, preferably 22 to 96, more preferably 28 to 72, and most preferably 28 to 40;
m represents the total charge of the polyoxometalate cluster and
m=S1*x1+S2*x2−2*y, wherein S1 is 5, and S2 is 4.

Particularly preferred embodiments of Formula (1) are the following Formulae (1-1) to (1-9):

[M¹₄O₁₂]⁴⁻ Formula (1-1)

[M¹₆O₁₉]⁸⁻ Formula (1-2)

[M¹₇O₂₂]⁹⁻ Formula (1-3)

[M¹₁₀O₂₈]⁶⁻ Formula (1-4)

[M¹₁₂O₄₀]¹⁴⁻ Formula (1-5)

[M¹₂₀O₅₄]⁸⁻ Formula (1-6)

[M¹₂₄O₇₂]²⁴⁻ Formula (1-7)

[M¹₂₇O₇₆]¹⁷⁻ Formula (1-8)

[M¹₃₂O₉₆]³²⁻ Formula (1-9)
wherein M¹ is a mixture of V and Nb, V and Ta, Nb and Ta, or V, Nb and Ta.

In said mixture, the individual components (V and Nb, V and Ta, Nb and Ta or V, Nb and Ta) can occur in any integer ratio based on the respective index for M¹.

Most preferred are Formulae (1-2) and (1-4).

Optionally, in Formulae (1-1) to (1-9) one or more M¹ can be replaced by M², wherein M² is Ti, Zr or Hf, preferably Ti. For each of such replacement of M¹, the polyoxometalate cluster's total negative charge increases by 1. In this case, the octahedral coordination of M² is retained.

Particularly preferred embodiments are the following Formulae (1-2-1) to (1-2-4) and (1-4-1) to (1-4-8):

[M¹⁵M²O₁₉]⁹⁻ Formula (1-2-1)

[M¹₄M²₂O₁₉]¹⁰⁻ Formula (1-2-2)

[M¹₃M²₃O₁₉]¹¹⁻ Formula (1-2-3)

[M¹₂M²₄O₁₉]¹²⁻ Formula (1-2-4)

[M¹₉M²O₂₈]⁷⁻ Formula (1-4-1)

[M¹₈M²₂O₂₈]⁸⁻ Formula (1-4-2)

[M¹₇M²₃O₂₈]⁹⁻ Formula (1-4-3)

[M¹₆M²₄O₂₈]¹⁰⁻ Formula (1-4-4)

[M¹₅M²₅O₂₈]¹¹⁻ Formula (1-4-5)

[M¹₄M²₆O₂₈]¹²⁻ Formula (1-4-6)

[M¹₃M²₇O₂₈]¹³⁻ Formula (1-4-7)

[M¹₂M²₈O₂₈]¹⁴⁻ Formula (1-4-8)
wherein M¹ is a mixture of V and Nb, V and Ta, Nb and Ta, or V, Nb and Ta; and M² is Ti, Zr or Hf, preferably Ti.

In a preferred embodiment of the present invention, the polyoxometalate compound further contains one or more cations, which are independently from each other selected from H⁺, Li⁺, Na⁺, K⁺, Rb⁺, Cs⁺, NH₄₋ₐRₐ⁺, Mg²⁺, Ca²⁺, Sr²⁺ and Ba²⁺, wherein R is an organic group; and a is an integer from 0 to 4, preferably 0 or 4, more preferably 4.

Preferably, R is at each occurrence independently from each other selected from an alkyl group having 1 to 10 carbon atoms or a hydroxyalkyl group having 1 to 10 carbon atoms, more preferably an alkyl group having 1 to 4 carbon atoms or a hydroxyalkyl group having 1 to 4 carbon atoms, most preferably methyl, ethyl, 1-propyl, 2-propyl, 1-butyl, 2-butyl, t-butyl, hydroxymethyl, 1-hydroxyethyl, 1-hydroxypropyl, 2-hydroxypropyl, 1-hydroxybutyl, and 2-hydroxybutyl.

It is particularly preferred that all R in NH₄₋ₐRₐ⁺ are the same.

The polyoxometalate compounds according to the present invention may contain one or more crystal water in its solid form and thus may exist as hydrates.

### Formulation

The present invention further relates to a formulation for preparing an optical metal oxide layer, wherein the formulation comprises:
(i) a polyoxometalate compound containing a polyoxometalate cluster, wherein the polyoxometalate cluster comprises one, two or three Group 5 elements, preferably selected from V, Nb and Ta; and
(ii) one or more formulation media.

If two or three Group 5 elements are comprised in the polyoxometalate cluster of the polyoxometalate compound, the Group 5 elements are different from each other.

It is preferred that the polyoxometalate cluster contained in the polyoxometalate compound in the formulation comprises one or two Group 5 elements selected from V, Nb and Ta. It is more preferred that the polyoxometalate cluster contained in the polyoxometalate compound in the formulation comprises one Group 5 element which is Nb.

In a preferred embodiment of the formulation for preparing an optical metal oxide layer according to the present invention, the polyoxometalate cluster further comprises one or more Group 4 elements, preferably selected from Ti, Zr and Hf. In case more Group 4 elements are comprised in the polyoxometalate cluster, the Group 4 elements are different from each other. In a more preferred embodiment of the formulation for preparing an optical metal oxide layer according to the present invention, the polyoxometalate cluster further comprises Ti.

In a preferred embodiment of the formulation for preparing an optical metal oxide layer according to the present invention, the polyoxometalate cluster is selected from poly (vanadates), poly (niobates), poly (tantalates), poly (vanadate-titanates), poly (niobate-titanates), poly (tantalate-titanates), poly (vanadate-zirconates), poly (niobate-zirconates), poly (tantalate-zirconates), poly (vanadate-hafniates), poly (niobate-hafniates), poly (tantalate-hafniates), poly (vanadate-niobates), poly (vanadate-tantalates), poly (niobate-tantalates), poly (vanadate-niobate-titanates), poly (vanadate-tantalate-titanates), poly (niobate-tantalate-titanates), poly (vanadate-niobate-zirconates), poly (vanadate-tantalate-zirconates), poly (niobate-tantalate-zirconates), poly (vanadate-niobate-hafniates), poly (vanadate-tantalate-hafniates), poly (niobate-tantalate-hafniates), poly (vanadate-niobate-tantalate-titanates), poly (vanadate-niobate-tantalate-zirconates), and poly (vanadate-niobate-tantalate-hafniates).

Preferred poly (vanadates) are tetra (vanadates), hexa (vanadates), deca (vanadates) and dodeca (vanadates). More preferred poly (vanadates) are hexa (vanadates) and deca (vanadates).

Preferred poly (niobates) are tetra (niobates), hexa (niobates), deca (niobates) and dodeca (niobates). More preferred poly (niobates) are hexa (niobates) and deca (niobates).

Preferred poly (tantalates) are tetra (tantalates), hexa (tantalates), deca (tantalates) and dodeca (tantalates). More preferred poly (tantalates) are hexa (tantalates) and deca (tantalates).

Preferred poly (vanadate-niobates) are tetra (vanadate-niobates), hexa (vanadate-niobates), deca (vanadate-niobates) and dodeca (vanadate-niobates). More preferred poly (vanadate-niobates) are hexa (vanadate-niobates) and deca (vanadate-niobates).

Preferred poly (vanadate-tantalates) are tetra (vanadate-tantalates), hexa (vanadate-tantalates), deca (vanadate-tantalates) and dodeca (vanadate-tantalates). More preferred poly (vanadate-tantalates) are hexa (vanadate-tantalates) and deca (vanadate-tantalates).

Preferred poly (niobate-tantalates) are tetra (niobate-tantatales), hexa (niobate-tantalates), deca (niobate-tantalates) and dodeca (niobate-tantalates). More preferred poly (niobate-tantalates) are hexa (niobate-tantalates) and deca (niobate-tantalates).

In a preferred embodiment of the present invention, the polyoxometalate cluster contained in the polyoxometalate compound in the formulation is represented by Formula (1):

[M¹ₓ₁M²ₓ₂O_{y}]^{m} Formula (1)

wherein:
M¹ is one or a mixture of two or three Group 5 elements, preferably selected from V, Nb and Ta, wherein preferably M¹ is a mixture of V and Nb, V and Ta, Nb and Ta, or V, Nb and Ta;
M² is one or a mixture of more Group 4 elements, preferably selected from Ti, Zr and Hf, wherein preferably M² is Ti, Zr or Hf, more preferably Ti;
O is oxygen;
x1 is an integer from 3 to 40, preferably 4 to 32, more preferably 6 to 24, even more preferably 6 to 12, and most preferably 10;
x2 is an integer from 0 to 40, preferably 0 to 32, more preferably 0 to 24, even more preferably 1 to 12, and most preferably 1, 2, 3, 4, 5, 6, 7, 8, 9 or 10;
wherein preferably x1+x2=3 to 40, preferably 4 to 32, more preferably 6 to 24, even more preferably 6 to 12, and most preferably 10;
y is an integer from 8 to 160, preferably 12 to 120, more preferably 22 to 96, even more preferably 28 to 72, and most preferably 28 to 40; and
m represents the total charge of the polyoxometalate cluster, wherein preferably m=S1*x1+S2*x2−2*y, wherein S1 represents the value of the oxidation state of M¹, preferably S1 is 2, 3, 4, or 5, more preferably S1 is 5, and S2 represents the value of oxidation state of M², preferably S2 is 2, 3 or 4, more preferably S2 is 4.

In a more preferred embodiment of the present invention, the polyoxometalate cluster contained in the polyoxometalate compound in the formulation is represented by Formula (1):

[M¹ₓ₁M²ₓ₂O_{y}]^{m} Formula (1)

wherein:
M¹ is one or a mixture of two or three Group 5 elements selected from V, Nb and Ta, wherein preferably M¹ is a mixture of V and Nb, V and Ta, Nb and Ta, or V, Nb and Ta;
M² is Ti, Zr or Hf, preferably Ti;
O is oxygen;
x1 is an integer from 3 to 40, preferably 4 to 32, more preferably 6 to 24, even more preferably 6 to 12, and most preferably 10;
x2 is an integer from 0 to 40, preferably 0 to 32, more preferably 0 to 24, even more preferably 1 to 12, and most preferably 1, 2, 3, 4, 5, 6, 7, 8, 9 or 10;
wherein x1+x2=3 to 40, preferably 4 to 32, more preferably 6 to 24, even more preferably 6 to 12, and most preferably 10;
y is an integer from 8 to 160, preferably 12 to 120, more preferably 22 to 96, even more preferably 28 to 72, and most preferably 28 to 40; and
m represents the total charge of the polyoxometalate cluster, wherein
m=S1*x1+S2*x2−2*y, wherein S1 is 5, and S2 is 4.

In a most preferred embodiment of the present invention, the polyoxometalate cluster contained in the polyoxometalate compound in the formulation is represented by Formula (1):

[M¹ₓ₁M²ₓ₂O_{y}]^{m} Formula (1)

wherein:
M¹ is a mixture of V and Nb, V and Ta, Nb and Ta, or V, Nb and Ta;
M² is Ti;
O is oxygen;
x1 is an integer from 4 to 32, preferably 6 to 24, more preferably 6 to 12, and most preferably 10;
x2 is an integer from 0 to 32, preferably 0 to 24, more preferably 1 to 12, and most preferably 1, 2, 3, 4, 5, 6, 7, 8, 9 or 10;
wherein x1+x2=4 to 32, preferably 6 to 24, more preferably 6 to 12, and most preferably 10;
y is an integer from 12 to 120, preferably 22 to 96, more preferably 28 to 72, and most preferably 28 to 40;
m represents the total charge of the polyoxometalate cluster and m=S1*x1+S2*x2−2*y, wherein S1 is 5, and S2 is 4.

Particularly preferred embodiments of Formula (1) are the following Formulae (1-1) to (1-9):

[M¹₄O₁₂]⁴⁻ Formula (1-1)

[M¹₆O₁₉]⁸⁻ Formula (1-2)

[M¹₇O₂₂]⁹⁻ Formula (1-3)

[M¹₁₀O₂₈]⁶⁻ Formula (1-4)

[M¹₁₂O₄₀]¹⁴⁻ Formula (1-5)

[M¹₂₀O₅₄]⁸⁻ Formula (1-6)

[M¹₂₄O₇₂]²⁴⁻ Formula (1-7)

[M¹₂₇O₇₆]¹⁷⁻ Formula (1-8)

[M¹₃₂O₉₆]³²⁻ Formula (1-9)
wherein M¹ is V, Nb or Ta; or a mixture of V and Nb, V and Ta, Nb and Ta, or V, Nb and Ta.

In said mixture, the individual components (V and Nb, V and Ta, Nb and Ta or V, Nb and Ta) can occur in any integer ratio based on the respective index for M¹.

Most preferred are Formulae (1-2) and (1-4).

Optionally, in Formulae (1-1) to (1-9) one or more M¹ can be replaced by M², wherein M² is Ti, Zr or Hf, preferably Ti. For each of such replacement of M¹, the polyoxometalate cluster's total negative charge increases by 1. In this case, the octahedral coordination of M² is retained.

Particularly preferred embodiments are the following Formulae (1-2-1) to (1-2-4) and (1-4-1) to (1-4-8):

[M¹⁵M²O₁₉]⁹⁻ Formula (1-2-1)

[M¹₄M²₂O₁₉]¹⁰⁻ Formula (1-2-2)

[M¹₃M²₃O₁₉]¹¹⁻ Formula (1-2-3)

[M¹₂M²₄O₁₉]¹²⁻ Formula (1-2-4)

[M¹₉M²O₂₈]⁷⁻ Formula (1-4-1)

[M¹₈M²₂O₂₈]⁸⁻ Formula (1-4-2)

[M¹₇M²₃O₂₈]⁹⁻ Formula (1-4-3)

[M¹₆M²₄O₂₈]¹⁰⁻ Formula (1-4-4)

[M¹₅M²₅O₂₈]¹¹⁻ Formula (1-4-5)

[M¹₄M²₆O₂₈]¹²⁻ Formula (1-4-6)

[M¹₃M²₇O₂₈]¹³⁻ Formula (1-4-7)

[M¹₂M²₈O₂₈]¹⁴⁻ Formula (1-4-8)
wherein M¹ is V, Nb or Ta; or a mixture of V and Nb, V and Ta, Nb and Ta, or V, Nb and Ta; and M² is Ti, Zr or Hf, preferably Ti.

In a preferred embodiment of the present invention, the polyoxometalate compound in the formulation further contains one or more cations, which are independently from each other selected from H⁺, Li⁺, Na⁺, K⁺, Rb⁺, Cs⁺, NH₄₋ₐRₐ⁺, Mg²⁺, Ca²⁺, Sr²⁺ and Ba²⁺, wherein R is an organic group; and a is an integer from 0 to 4, preferably 0 or 4, more preferably 4.

Preferably, R is at each occurrence independently from each other selected from an alkyl group having 1 to 10 carbon atoms or a hydroxyalkyl group having 1 to 10 carbon atoms, more preferably an alkyl group having 1 to 4 carbon atoms or a hydroxyalkyl group having 1 to 4 carbon atoms, most preferably methyl, ethyl, 1-propyl, 2-propyl, 1-butyl, 2-butyl, t-butyl, hydroxymethyl, 1-hydroxyethyl, 1-hydroxypropyl, 2-hydroxypropyl, 1-hydroxybutyl, and 2-hydroxybutyl.

It is particularly preferred that all R in NH₄₋ₐRₐ⁺ are the same.

Preferably, the content of the polyoxometalate compounds in the formulation is in the range from 0.1% to 50% w/w, preferably 0.5% to 40% w/w, more preferably 1% to 30% w/w, based on the total mass of the formulation.

In a preferred embodiment of the present invention, the one or more formulation media are solution media and/or dispersion media. The formulation media are selected to improve applicability, wettability, deposition properties, filling properties and/or stability of the formulation. Any formulation media can be used as long as it dissolves or disperses the polyoxometalate compounds comprised in the formulation according to the present invention.

In a more preferred embodiment of the present invention, the one or more formulation media are selected from water, alcohols, carboxylic acids, and mixtures thereof.

In a most preferred embodiment of the present invention, the one or more formulation media are selected from water, alcohols, and mixtures thereof.

Preferred alcohols are C1-C12 alkyl alcohols, C1-C4 alkoxy-C1-C12 alkyl alcohols, C6-C10 aryl alcohols and/or C6-C10 aryl-C1-C4 alkyl alcohols such as preferably methanol, ethanol, propanol, butanol, pentanol, hexanol, heptanol, octanol, nonanol, decanol, allyl alcohol, vinyl alcohol, methoxy-propanol, methoxy-butanol, methoxy-pentanol, methoxy-hexanol, methoxy-heptanol, methoxy-octanol, methoxy-nonanol, methoxy-decanol, ethoxy-propanol, ethoxy-butanol, ethoxy-pentanol, ethoxy-hexanol, ethoxy-heptanol, ethoxy-octanol, ethoxy-nonanol, ethoxy-decanol, phenol, cresol, naphthol and benzyl alcohol.

Preferred carboxylic acids are C1-C12 alkyl carboxylic acids, C6-C10 aryl carboxylic acids and/or C6-C10 aryl-C1-4 alkyl carboxylic acids such as preferably formic acid, acetic acid, propionic acid, benzoic acid and benzylic acid.

Particularly preferred formulation media are selected from 1-methoxy-2-propanol, n-butanol, a mixture of 1-methoxy-2-butanol with water, and a mixture of n-butanol with water.

It is preferred that any binary, tertiary, quaternary or higher mixtures of the aforementioned formulation media are used in the present invention.

In a preferred embodiment of the present invention, the formulation further comprises (iii) one or more additives selected from surfactants, wetting and dispersion agents, adhesion promoters, and polymer matrices.

Preferred surfactants are surface active substances, which preferably include surface active metal oxides and/or surface-active organic compounds. Surface-active organic compounds may include nonionic surfactants, anionic surfactants, and ampholytic surfactants and they may be coordinating or non-coordinating.

Examples of nonionic surfactants include, polyoxyethylene alkyl ethers, such as polyoxyethylene lauryl ether, polyoxyethylene oleyl ether and 30 polyoxyethylene cetyl ether; polyoxyethylene fatty acid diester; polyoxyethylene fatty acid monoester; polyoxyethylene polyoxypropylene block polymer; acetylene alcohol; acetylene glycol; polyethoxylate of acetylene alcohol; acetylene glycol derivatives, such as polyethoxylate of acetylene glycol; fluorine-containing surfactants, for example, FLUORAD (trade name, manufactured by Sumitomo 3M Limited), MEGAFAC (trade name: manufactured by DIC Cooperation), SURFLON (trade name, 5 manufactured by Asahi Glass Co. Ltd); or organosiloxane surfactants, for example, KP341 (trade name, manufactured by Shin-Etsu Chemical Co., Ltd.), and the like. Examples of said acetylene glycol include 3-methyl-1-butyne-3-ol, 3-methyl-1-pentyn-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-10 hexyne-2,5-diol, 2,5-dimethyl-2,5-hexane-diol, and the like.

Examples of anionic surfactants include ammonium salt or organic amine salt of alkyl diphenyl ether disulfonic acid, ammonium salt or organic amine salt of alkyl diphenyl ether sulfonic acid, ammonium salt or organic amine 15 salt of alkyl benzene sulfonic acid, ammonium salt or organic amine salt of polyoxyethylene alkyl ether sulfuric acid, ammonium salt or organic amine salt of alkyl sulfuric acid, and the like.

Examples of amphoteric surfactants include 2-alkyl-N-carboxymethyl-N-20 hydroxyethyl imidazolium betaine, lauric acid amide propyl hydroxysulfone betaine, and the like.

Preferred surface-active metal oxides are selected from the list consisting of aluminum oxide, calcium oxide, silica, and zinc oxide. Such surface-active metal oxides are preferably present as fine powders, more preferably as nanoparticles, which are optionally surface treated.

Preferred surface-active organic compounds are surface-active non-polymeric compounds or surface-active polymeric organic compounds, wherein said surface-active non-polymeric compounds are preferably selected from the list consisting of alcohols, alkoxylates, aromatics, ketones, esters, modified urea, silanes, siloxanes and soap-based foam stabilizers, which are optionally functionalized and/or modified; and wherein said surface-active polymeric compounds are preferably selected from the list consisting of hydroxy polyesters, maleinate resins, polyacrylates, polyethers, polyester, polysilanes, silicone resins, and waxes, which are optionally functionalized and/or modified; and which are optionally present as copolymers. In a preferred embodiment, the surface-active organic compound is used as a solution.

Preferred silanes are polyether-modified silanes, polyester-modified silanes, and polyether-polyester-modified silanes. Preferred siloxanes are polyether-modified siloxanes, polyester-modified siloxanes, and polyether-polyester-modified siloxanes.

Preferred polyacrylates are modified polyacrylates, preferably silicone-modified polyacrylates, polyether macromer-modified polyacrylates, and silicone and polyether macromer-modified polyacrylates, which are optionally present as copolymers.

Preferred polysilanes are polyether-modified polysilanes (e.g. PEG-Silane 6-9), polyester-modified polysilanes, and polyether-polyester-modified polysilanes.

Preferred silicone resins are polyether-modified polysiloxanes, preferably polyether-modified polydialkylsiloxanes, more preferably polyether-modified polymethylalkylsiloxanes, and most preferably polyether-modified polydimethylsiloxanes and polyether-modified, hydroxy-functional polydimethylsiloxanes; polyester-modified polysiloxanes, preferably polydialkylsiloxanes, more preferably polyester-modified polymethylalkylsiloxanes, and most preferably polyester-modified polydimethylsiloxanes and polyester-modified, hydroxy-functional polydimethylsiloxanes; polyether-polyester-modified polysiloxanes, preferably polyether-polyester-modified polydialkylsiloxanes, more preferably polyether-polyester-modified polymethylalkylsiloxanes, and most preferably polyether-polyester-modified polydimethylsiloxanes and polyether-polyester-modified, hydroxy-functional polydimethylsiloxanes; epoxy functional polysiloxanes, preferably epoxy functional polydialkylsiloxanes, more preferably epoxy functional polymethylalkylsiloxanes, and most preferably epoxy functional polydimethylsiloxanes; acryl functional polysiloxanes, preferably acryl functional polydialkylsiloxanes, more preferably acryl functional polymethylalkylsiloxanes, and most preferably acryl functional polydimethylsiloxanes; polyether-modified, acryl functional polysiloxanes, preferably polyether-modified, acryl-functional polydialkylsiloxanes, more preferably polyether-modified, acryl-functional polymethylalkylsiloxanes, and most preferably polyether-modified, acryl-functional polydimethylsiloxanes; polyester-modified, acryl-functional polysiloxanes, preferably polyester-modified, acryl-functional polydialkylsiloxanes, more preferably polyester-modified, acryl-functional polymethylalkylsiloxanes, and most preferably polyester-modified, acryl-functional polydimethylsiloxanes; and aralkyl-modified polysiloxanes, preferably aralkyl-modified polydialkylsiloxanes, more preferably aralkyl-modified polymethylalkylsiloxanes, and most preferably aralkyl-modified polydimethylsiloxanes; which are optionally present as copolymers.

Preferred surfactants are commercially available from BYK-Chemie GmbH, Wesel, Germany and offered as surface additives. Preferred surfactants are BYK-300, BYK-301, BYK-302, BYK-306, BYK-307, BYK-310, BYK-313, BYK-315 N, BYK-320, BYK-322, BYK-323, BYK-325 N, BYK-326, BYK-327, BYK-329, BYK-330, BYK-331, BYK-332, BYK-333, BYK-342, BYK-345, BYK-346, BYK-347, BYK-348, BYK-349, BYK-350, BYK-352, BYK-354, BYK-355, BYK-356, BYK-358 N, BYK-359, BYK-360 P, BYK-361 N, BYK-364 P, BYK-366 P, BYK-368 P, BYK 370, BYK 375, BYK-377, BYK-378, BYK-381, BYK-390, BYK-392, BYK-394, BYK-399, BYK-2616, BYK-3400, BYK-3410, BYK-3420, BYK-3450, BYK-3451, BYK-3455, BYK-3456, BYK-3480, BYK-3481, BYK-3499, BYK-3550, BYK-3560, BYK-3565, BYK-3566, BYK-3750, BYK-3751, BYK-3752, BYK-3753, BYK-3754, BYK-3760, BYK-3761, BYK-3762, BYK-3763, BYK-3764, BYK-3770, BYK-3771, BYK-3780, BYK-3900 P, BYK 3902 P, BYK-3931 P, BYK 3932 P, BYK-3933 P, BYK-8020, BYK-8070, BYK-9890, BYK-DYNWET 800, BYK-S 706, BYK-S 732, BYK-S 740, BYK-S 750 N, BYK-S 760, BYK-S 780, BYK-S 782, BYK-SILCELAN 3700, BYK-SILCLEAN 3701, BYK-SILCLEAN 3710, BYK-SILCLEAN 3720, BYK-UV 3500, BYK-UV 3505, BYK-UV 3510, BYK-UV 3530, BYK-UV 3535, BYK-UV 3570, BYK-UV 3575, BYK-UV 3576, BYKETOL-AQ, BYKETOL-OK, BYKETOL-PC, BYKETOL-SPECIAL, BYKETOL-WA, NANOBYK-3603, NANOBYK-3605, NANOBYK-3620, NANOBYK-3650, NANOBYK-3652, and NANOBYK-3822.

The wetting and dispersion agents used in the present invention are additives, which provide both wetting and/or stabilizing effects for formulations containing fine solid particles. They result in a fine and homogenous distribution of solid particles in a formulation media, preferably liquid formulation media, and ensure long-term stability of such systems. The formulation media may comprise water and the entire range of organic solvents of varying polarity. Moreover, they result in an improved wetting of solids and prevent particles from flocculating by various mechanisms (e.g. by electrostatic effects, steric effects, etc.).

Preferably, the wetting and dispersion agents are organic polymers or organic copolymers having polar functional groups selected from amino groups; amide groups; carbamate groups; carbonate groups; acidic groups, preferably boric acid groups, boronic acid groups, carboxylic acid groups, sulfuric acid groups, sulfonic acid groups, phosphoric acid groups, phosphonic acid groups, and phosphinic acid groups; ester groups, preferably boric ester groups, boronic ester groups, carboxylic ester groups, sulfuric ester groups, sulfonic ester groups, phosphoric ester groups, phosphonic ester groups, and phosphinic ester groups; ether groups; hydroxy groups; keto groups; and urea groups; wherein the organic polymers or copolymers may be present as a conjugate, derivative and/or salt, preferably as a salt. Preferred salts are ammonium salts, alkyl ammonium salts, alkylol ammonium salts, or alkaline metal salts such as preferably Li, Na, K and Rb salts. The polar functional groups may be also referred to as pigment-affinic groups or as filler-affinic groups. In a preferred embodiment, the wetting and dispersion agent is used as a solution.

More preferably, the wetting and dispersion agents are organic polymers or organic copolymers selected from acrylates; amides; carboxylic acids; and esters; wherein the organic polymers or copolymers may be present as a conjugate, derivative and/or salt, preferably as a salt; and wherein they may be further functionalized with one or more polar functional group as described above. Preferred salts are ammonium salts, alkyl ammonium salts, alkylol ammonium salts, or alkaline metal salts such as preferably Li, Na, K and Rb salts. In a preferred embodiment, the wetting and dispersion agent is used as a solution.

The wetting and dispersion agents may be present as a mixture, preferably as a mixture with a polysiloxane copolymer.

Preferred wetting and dispersing agents are commercially available from BYK-Chemie GmbH, Wesel, Germany. Preferred wetting and dispersing agents are ANTI-TERRA-202, ANTI-TERRA-203, ANTI-TERRA-204, ANTI-TERRA-205, ANTI-TERRA-210, ANTI-TERRA-250, ANTI-TERRA-U, ANTI-TERRA-U 80, ANTI-TERRA-U 100, BYK-151, BYK-153, BYK-154, BYK-155/35, BYK-156, BYK-220 S, BYK-1160, BYK-1162, BYK-1165, BYK-9076, BYK-9077, BYK-GO 8702, BYK-GO 8720, BYK-P 104, BYK-P 104 S, BYK-P 105, BYK-SYNERGIST 2100, BYK-SYNERGIST 2105, BYK-W 900, BYK-W 903, BYK-W 907, BYK-W 908, BYK-W 909, BYK-W 940, BYK-W 961, BYK-W 966, BYK-W 969, BYK-W 972, BYK-W 974, BYK-W 980, BYK-W 985, BYK-W 995, BYK-W 996, BYK-W 9010, BYK-W 9011, BYK-W 9012, BYKJET-9131, BYKJET-9132, BYKJET-9133, BYKJET-9142, BYKJET-9150, BYKJET-9151, BYKJET-9152, BYKJET-9170, BYKJET-9171, BYKUMEN, DISPERBYK, DISPERBYK-101 N, DISPERBYK-102, DISPERBYK-103, DISPERBYK-106, DISPERBYK-107, DISPERBYK-108, DISPERBYK-109, DISPERBYK-110, DISPERBYK-111, DISPERBYK-115, DISPERBYK-118, DISPERBYK-130, DISPERBYK-140, DISPERBYK-142, DISPERBYK-145, DISPERBYK-161, DISPERBYK-162, DISPERBYK-162 TF, DISPERBYK-163, DISPERBYK-163 TF, DISPERBYK-164, DISPERBYK-165, DISPERBYK-166, DISPERBYK-167, DISPERBYK-167 TF, DISPERBYK-168, DISPERBYK-168 TF, DISPERBYK-169, DISPERBYK-170, DISPERBYK-171, DISPERBYK-174, DISPERBYK-180, DISPERBYK-181, DISPERBYK-182, DISPERBYK-184, DISPERBYK-185, DISPERBYK-187, DISPERBYK-190, DISPERBYK-190 BF, DISPERBYK-191, DISPERBYK-192, DISPERBYK-193, DISPERBYK-194 N, DISPERBYK-199, DISPERBYK-199 BF, DISPERBYK-2000, DISPERBYK-2001, DISPERBYK-2008, DISPERBYK-2009, DISPERBYK-2010, DISPERBYK-2012, DISPERBYK-2013, DISPERBYK-2014, DISPERBYK-2015, DISPERBYK-2015 BF, DISPERBYK-2018, DISPERBYK-2019, DISPERBYK-2022, DISPERBYK-2023, DISPERBYK-2025, DISPERBYK-2026, DISPERBYK-2030, DISPERBYK-2050, DISPERBYK-2055, DISPERBYK-2059, DISPERBYK-2060, DISPERBYK-2061, DISPERBYK-2062, DISPERBYK-2070, DISPERBYK-2080, DISPERBYK-2081, DISPERBYK-2096, DISPERBYK-2117, DISPERBYK-2118, DISPERBYK-2150, DISPERBYK-2151, DISPERBYK-2152, DISPERBYK-2155, DISPERBYK-2155 TF, DISPERBYK-2157, DISPERBYK-2158, DISPERBYK-2159, DISPERBYK-2163, DISPERBYK-2163 TF, DISPERBYK-2164, DISPERBYK-2190, DISPERBYK-2200, DISPERBYK-2205, DISPERBYK-2290, DISPERBYK-2291, DISPERPLAST-1142, DISPERPLAST-1148, DISPERPLAST-1150, DISPERPLAST-1180, DISPERPLAST-I, and DISPERPLAST-P.

Preferred adhesion promoters are block copolymers, preferably high molecular weight block copolymers; copolymers with functional groups, preferably hydroxy-functional copolymers with acidic groups, styrene-ethylene/butylene-styrene block copolymer (SEBS) functionalized with maleic acid anhydride, carboxylated SEBS functionalized with maleic anhydride, SEBS functionalized with glycidyl methacrylate, polyolefin block copolymer functionalized with maleic acid anhydride, and ethylene octene copolymer functionalized with maleic anhydride; and polymers with functional groups, preferably polymers with acidic groups, and polypropylene functionalized with maleic anhydride. In a preferred embodiment, the adhesion promoter is used as a solution.

Preferred adhesion promoters are commercially available from BYK-Chemie GmbH, Wesel, Germany. Preferred adhesion promoters are BYK-4500, BYK-4509, BYK-4510, BYK-4511, BYK-4512, BYK-4513, SCONA TPKD 8102 PCC, SCONA TSIN 4013 GC, SCONA TSPOE 1002 GBLL, SCONA TPPP 2112 FA, SCONA TPPP 2112 GA, SCONA TPPP 8112 GA, SCONA TSKD 9103, SCONA TPPP 8112 FA, SCONA TPKD 8304 PCC, and SCONA TSPP 10213 GB.

Preferred polymer matrices are polymethyl methacrylate, polyvinylpyrrolidone, polycarbonate, polystyrene, polymethylpentene, and silicone.

It is particularly preferred that a combination of two or more of the above-mentioned additives are present in the formulation.

In a preferred embodiment of the present invention, the content of the additives in the formulation is from >0% to ≤10% w/w, preferably >0.01% to <9% w/w, more preferably >0.05% to <7.5% w/w, and most preferably >0.1% to <5.0 w/w, based on the total mass of the formulation.

In a preferred embodiment of the present invention, the formulation comprises one or more further metal complexes, which may act as further metal oxide precursors. In such case, a mixed optical metal oxide layer may be formed comprising a metal oxide obtained from the polyoxometalate compound and a further metal oxide obtained from the further metal oxide precursors.

Preferred further metal complexes comprise one or more trivalent or tetravalent metals, preferably selected from the list consisting of Sc, Y, La, Ti, Zr, Hf and Sn, more preferably one or more tetravalent metals selected from the list consisting of Ti, Zr, Hf and Sn.

In a preferred embodiment of the present invention, the formulation comprises one, two, three, four or more further metal complexes in addition to the polyoxometalate compound, where preferably each of the further metal complexes contains ligands selected from inorganic ligands or organic ligands. Preferred inorganic ligands are halogenides, phosphoric acid, sulfonic acid, nitric acid and water, which are optionally deprotonated. Preferred organic ligands are alcohols, carboxylic acids, cyanates, isocyanates, 1,3-diketones, beta-keto acids, beta-keto esters, organylphosphonic acids, organylsulfonic acids, oximes, hydroxamic acids, dihydroxy benzenes, hydroxybenzoic acids, dihydroxy benzoic acids, gallic acid, dihydroxynaphthalenes, anthracene diols, hydroxy-anthrones, anthracene triols, dithranols, halogenated hydrocarbons, aromatics, heteroaromatics, esters, catechols, coumarins and their derivatives, which are optionally deprotonated.

The presence of such further metal complexes allows to adjust certain properties of the optical metal oxide layer prepared therefrom such as e.g. material hardness, shrinkage, refractive index, transparency, absorbance, and haze suppression.

Preferably, the mass ratio w/w between the polyoxometalate compound and the one or more further metal complexes in the formulation is in the range from 1:100 to 100:1, preferably from 1:10 to 10:1, and more preferably from 1:5 to 5:1.

It is preferred that the total content of the polyoxometalate compound and the further metal complexes contained in the formulation is in the range from 0.1% to 50% w/w, preferably 0.5% to 40% w/w, more preferably 1% to 30% w/w, based on the total mass of the formulation.

In a preferred embodiment of the present invention, the formulation is an ink formulation being suitable for inkjet printing. Typical requirements for ink formulations are surface tensions in the range from 20 mN/m to 30 mN/m and viscosities in the range from 5 mPa's to 10 mPa·s.

### Method for Preparing Optical Metal Oxide Layer

The present invention relates to a method for preparing an optical metal oxide layer, wherein the method comprises the following steps (a) to (c):
(a) providing a formulation according to the present invention;
(b) applying the formulation to a surface of a substrate; and
(c) converting the formulation on the surface of the substrate to an optical metal oxide layer.

In a preferred embodiment of the present invention, the formulation provided in step (a) of the method for preparing an optical metal oxide layer is an ink formulation being suitable for inkjet printing. Typical requirements for ink formulations are surface tensions in the range from 20 mN/m to 30 mN/m and viscosities in the range from 5 mPa's to 10 mPa·s.

In a preferred embodiment of the method for preparing an optical metal oxide layer according to the present invention, the formulation is applied in step (b) to a surface of a substrate by a deposition method. A preferred deposition method is drop casting, coating, or printing. A more preferred coating method is spin coating, spray coating, slit coating, or slot-die coating. A more preferred printing method is flexo printing, gravure printing, inkjet printing, EHD printing, offset printing, or screen printing. Most preferred are spray coating and inkjet printing.

Depending on the specific problem to be solved, the formulation needs to be deposited either as a homogeneous, dense and thin layer covering the entire surface of the substrate by a coating method or the formulation needs to be deposited locally in a structured manner, thus requiring for a printing method. Both, coating and printing methods require formulations to be formulated in an adequate manner to comply with the physico-chemical needs of the respective coating and printing method as well as to comply with certain needs regarding the surface of the substrate to be coated or printed.

In a preferred embodiment of the method for preparing an optical metal oxide layer according to the present invention, the surface of the substrate is pre-treated by a surface cleaning process. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet cleaning process involving cleaning solvents (e.g. isopropanol (IPA)); wet etching processes involving hydrogen peroxide solutions (e.g. piranha solution, SC1, and SC2), choline solutions, or HF solutions; dry etching processes involving chemical vapor etching, UV/ozone treatments or glow discharge techniques (e.g. O₂ plasma etching); and mechanical processes involving brush scrubbing, fluid jet or ultrasonic techniques (sonification). The surface of the substrate can also be pre-treated by silanization or an atomic layer deposition (ALD) process. The pre-treatment of the surface of the substrate serves to modify the hydrophobicity/hydrophilicity of the surface. This can improve the adhesion and filling characteristics of the optical metal oxide layer on the surface of the substrate.

In a more preferred embodiment, a wet cleaning process involving cleaning solvents (e.g. isopropanol (IPA)) is combined with one or more of a wet etching process involving hydrogen peroxide solutions (e.g. piranha solution, SC1, and SC2), choline solutions, or HF solutions; dry etching process involving chemical vapor etching, UV/ozone treatments or glow discharge techniques (e.g. O₂ plasma etching); and mechanical process involving brush scrubbing, fluid jet or ultrasonic techniques (sonification).

In a most preferred embodiment, a wet cleaning process involving cleaning solvents (e.g. isopropanol (IPA)) is combined with a mechanical process involving brush scrubbing, fluid jet or ultrasonic techniques (sonification) and with a wet etching process involving hydrogen peroxide solutions (e.g. piranha solution, SC1, and SC2), choline solutions, or HF solutions;

In a preferred embodiment of the present invention, step (b) of the method for preparing an optical metal oxide layer is carried out several times in succession, preferably 2 to 20 times, more preferably 2 to 10 times, most preferably 2, 3, 4 or 5 times.

In a preferred embodiment of the method for preparing an optical metal oxide layer according to the present invention, the formulation is converted in step (c) on the surface of the substrate to an optical metal oxide layer by exposure to thermal treatment and/or irradiation treatment.

Preferred thermal treatment includes exposure to elevated temperatures as high as 1200° C., preferably up to 600° C., more preferably up to 550° C. and most preferably up to 500° C. Thermal treatment is not limited to any specific thermal treatment methods or times. Depending on the type of substrate and formulation, a person skilled in the art is able to determine suitable thermal treatment methods and times.

Preferred irradiation treatment includes exposure to infrared (IR) light, visible (Vis) light and/or ultraviolet (UV) light. IR light has a wavelength of >800 nm. Vis light has a wavelength from 400 to 800 nm. UV light has a wavelength of <400 nm and may include EUV (extreme UV). Irradiation treatment is not limited to any specific irradiation treatment methods or times. Depending on the type of substrate and formulation, a person skilled in the art is able to determine suitable irradiation treatment methods and times.

In a more preferred embodiment of the method for preparing an optical metal oxide layer according to the present invention, the formulation is converted in step (c) on the surface of the substrate to an optical metal oxide layer by pre-baking (soft baking) at a temperature from 40 to 150° C., preferably from 50 to 120° C., more preferably from 60 to 100° C.; and then baking (hard baking, sintering or annealing) at a temperature from 150 to 600° C., preferably from 250 to 550° C., more preferably from 300 to 500° C.

Pre-baking (soft baking) serves the purpose to remove volatile and low boiling components such as e.g. volatile and low boiling formulation media or additives from the drop casted, coated or printed films. Pre-baking is preferably carried out for a period of 1 to 10 minutes. After pre-baking, layers of substrate adhering films of metal oxide precursor or metal oxide precursor mixtures are obtained. The films may still comprise residual formulation media or additives.

In an alternative more preferred embodiment of the method for preparing an optical metal oxide layer according to the present invention, pre-baking can be omitted so that the formulation is converted in step (c) on the surface of the substrate to an optical metal oxide layer directly by baking (hard baking, sintering or annealing) at a temperature from 150 to 600° C., preferably from 250 to 550° C., more preferably from 300 to 500° C.

Baking (hard baking, sintering or annealing) serves the purpose to convert the metal oxide precursor or metal oxide precursor mixture layers on the substrate into a metal oxide layer. Moreover, the final properties of the metal oxide layer may be adjusted by the baking treatment. Baking is preferably carried out for a period of 1 to 300 minutes, preferably 1 to 60 minutes to achieve a refractive index (RI) of >2.0.

Pre-baking and baking may be carried out under ambient atmosphere or atmospheres with increased oxygen content in order to decompose unwanted organic components, which can lead to a lower activation energy when the metal oxide layers are formed.

In a preferred embodiment of the method for preparing an optical metal oxide layer according to the present invention, the substrate is a patterned substrate comprising topographical features and the metal oxide forms a coating layer covering the surface of the substrate and filling said topographical features. As a result, the topographical features are filled and levelled by said metal oxide.

Preferred topographical features include, for example, gaps, grooves, trenches and vias. Topographical features may be distributed uniformly or non-uniformly over the surface of the substrate. Preferably, they are arranged as an array or grating on the surface of the substrate. It is preferred that the topographical features have different lengths, widths, diameters as well as different aspect ratios. It is preferred that said topographical features have an aspect ratio of 1:20 to 20:1, more preferably 1:10 to 10:1. The aspect ratio is defined as width of structure to its height (or depth). From the viewpoint of dimension, the depth of the topographical features is preferably in the range from 10 nm to 10 μm, more preferably 50 nm to 5 μm, and most preferably 100 nm to 1 μm.

It is also preferred that the topographical features are inclined at a certain angle, such as an angle from 10 to 80°, preferably from 20 to 60°, more preferably from 30 to 50°, most preferably about 40°. Such inclined topographical features are also referred to as slanted or blazed topographical features.

It may be also necessary to fill topographical features locally with optical metal oxide layer, either completely or to a certain level, but not to cover adjacent surfaces of the substrate, where no topographical features to be filled are available.

Hence, it is preferred that the method for preparing an optical metal oxide layer according to the present invention further comprises the following step (d):
(d) removing a portion of said optical metal oxide layer covering the top of the topographical features, thereby obtaining filled topographical features, wherein an overburden of the optical metal oxide layer on top of said topographical features is reduced, preferably to an overburden of between 0 to 100 nm, more preferably between 0 to 50, and most preferably between 0 to 20 nm.

Step (d) takes place after steps (a) to (c) of the method according to the present invention. Preferably, removing a portion of said optical metal oxide layer covering a top of the topography in step (d) is performed by using a surface cleaning process as described above. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet-etching processes involving hydrogen peroxide solutions (e.g. piranha solution, SC1, and SC2), choline solutions, or HF solutions; dry-etching processes involving chemical vapor etching, UV/ozone treatments or glow discharge techniques (e.g. O₂ plasma etching); and mechanical processes involving brush scrubbing, fluid jet or ultrasonic techniques.

The substrate is preferably a substrate of an optical device. Preferred substrates are made of inorganic or organic base materials, preferably inorganic base materials. Preferred inorganic base materials contain materials selected from the list consisting of ceramics, glass, fused silica, sapphire, silicon, silicon nitride, quartz, and transparent polymers or resins. The geometry of the substrate is not specifically limited, however, preferred are sheets or wafers.

In step (b) of the method for preparing an optical metal oxide layer, the formulation is applied on a surface of a substrate, wherein said surface may be either a surface of a base material of the substrate or a surface of a layer of a material being different from the base material of the substrate, wherein such layer has been formed prior to applying said formulation.

In this way, sequences of different layers (layer stacks) can be formed on top of one another. Such layer stacks may be also structured, wherein such structures typically have dimensions in the nanometer scale, at least with respect to diameter, width and/or aspect ratio.

### Optical Device

Finally, the present invention relates to an optical device comprising an optical metal oxide layer, which is obtainable or obtained by the method for preparing an optical metal oxide layer according to the present invention as described above. It is preferred that the optical device is an augmented reality (AR) and/or virtual reality (VR) device.

Finally, the present invention further relates to an optical device comprising an optical metal oxide layer, which is prepared by using the formulation according to the present invention as described above. It is preferred that the optical device is an augmented reality (AR) and/or virtual reality (VR) device.

The present invention is further illustrated by the examples following hereinafter which shall in no way be construed as limiting. The skilled person will acknowledge that various modifications, additions and alternations may be made to the invention without departing from the spirit and scope of the invention as defined in the appended claims.

### EXAMPLES

### Analytics and Measurement Methods

Ellipsometry was used to determine layer thickness, refractive index (n) and absorption index (k) of a metal oxide layer. Measurements were performed using an ellipsometer M2000 from J. A. Woolam and three different angles of incidence (65°, 70° and) 75°. The measurement data was analyzed with software CompleteEase from J. A. Woolam, assuming either full or almost nearly complete transparent behavior above a wavelength of 600 nm and applying B-spline fitting for obtaining refractive indices (n) as well as absorption indices (k). The optical constants were averaged from three to four measured samples each of them providing a different layer thickness either after soft bake or after hard bake or after combined soft and subsequent hard bake.

Optical spectra of any sheets and substrates being either coated or uncoated by metal oxide layers described in the present invention were recorded using UV/Vis/NIR-spectrophotometer Cary 7000 from Agilent with UMA-setup. Measurements were carried out using dual beam mode, a scan speed of 600 nm/min and a spectral band width of 4 nm, non-polarized light and applying a spectral window from 350 nm to 700 nm. Transmission measurements were carried out with an angle of incidence of 6° versus surface normal of the sample. The detector was aligned 180° to light incidence. Reflection measurements were carried out with an angle of incidence of 6° versus surface normal of the sample, the detector angle amounted to 12° versus incidence of light. The absorption of the samples was calculated using Equation 1, where A stands for the absorption of the coated sample, R stands for the reflection and T for the transmission of the sample.

$$A = 1 - ( R + T ) \qquad Equation 1$$

Thermogravimetric analysis was run on a TGA Q 50 from TA Instruments. In the usual measurement mode, the sample was heated up to 950° C. in air atmosphere applying a heating ramp of 20 K/min.

Results upon elementary analysis were received as service from an analytical service provider where measurements were conducted according to DIN 51732:2014-07.

NMR-measurements, ¹H-NMR, were measured using 500 MHZ spectrometer from Bruker Biospin GmbH.

ICP-OES metal analysis was run on a FHS12 System from Spectro Arcos SOP after chemical pulping of the analyte subjected to analysis.

FTIR-spectra were recorded on Bruker Vertex 70 in ATR-mode, typically applying a spectral window from 4,000 to 400 cm⁻¹ with spectral resolution of 2 cm⁻¹.

SEM images were recorded using either a Mira 3 LMU from Tescan or Sigma 300VP from Carl Zeiss or Supra 35 from Carl Zeiss, too.

MALDI-TOF-MS-spectra were recorded on Bruker Datonics Ultraflextreme applying positive ion mode, thus detecting [M+H]⁺ ions as well as similars (adducts with sodium, potassium, ions including loss of water by internal re-arrangement). In MALDI-MS, predominantly singly charged ions are generated (z=1). The shown spectra were recorded in Reflector mode to achieve isotopic resolution. The smartbeam 2 laser (IR) is operated at frequency of 1000 Hz. Generally, the analyte was dissolved in THF (where applicable) at 10 mg/ml scale and 0.5 μL droplets were prepared on a ground steel target. DCTB (trans-2-[3-(4-tert-butylphenyl)-2-methyl-2-propenylidene]malononitrile) was used as MALDI matrix.

Substrate coating, usually wafers, was done using a spin coater (LabSpin 150i) from Suess. The spin coating process using planar substrates was as follows: deposition of 0.5 ml of the coating onto static quartz wafers followed by a spinning interval of 30 seconds at a given spin speed where the acceleration to reach the final spin speed was set to 500 rpm/s2. Different layer and coating thicknesses were achieved using either different spin speeds or different coating formulations having different concentrations of the metal oxide precursor or mixtures of different metal oxide precursors. After spin coating, the coated substrates either underwent pre-baking at 100° C. for 2 minutes for driving out solvent residues, subsequently followed by baking at elevated temperatures or the layers deposited on the wafers became directly baked at elevated temperature for a dedicated time. Usually, however not limited hereto, the coated layers were baked at 300° C., 400° C. and 500° C. for 5 minutes as well as for 60 minutes as shown in some of the following examples. Pre-baking as well as layer baking were performed using high temperature hotplates from Harry Gestigkeit allowing for reaching temperatures of up to 600° C. Aforementioned conditions and parameters apply to all following experimental examples unless other conditions are explicitly mentioned elsewhere.

Usually, quartz and/or silicon wafers, both 2″ in diameter, were used throughout all coating experiments where flat and non-structured carriers for metal oxides were required (e. g. spectroscopic and ellipsometry measurements).

Structured substrates, usually silicon wafers, were used as square-shaped dies with edge length of 1.5 cm to 2 cm. The wafer dies were cut and cleaved from a parent wafer, typically having a diameter of 8″. The structures were created and arranged in a layer stack composed of SiO₂/SiNₓ being deposited onto the wafer surface. Dimensions of the structures (e. g. cross-section width and length of trenches) referred to the architecture of Sematech mask 854. Usually, however not limited hereto, the cross-sectional cleaves perpendicular to trench arrays providing a width of 40 nm to 50 nm were used as trench structures of primary interest to investigate their filling behavior by the wet-chemically coated metal oxide precursors and/or metal oxides received upon thermal conversion of the said metal oxide precursors. Besides to aforementioned, cross-sections of arrays of trenches having widths of 100 nm and 150 nm where used to investigate trench filling by metal oxides, too.

Structured wafer dies were, unless otherwise mentioned, coated by spin coating. For that purpose, the coating formulation, typically a volume between 0.15 ml to 0.5 ml per die, was pipetted and casted onto wafer's surface. The formulation was allowed to spread and settle on the surface for one minute followed by a step of distributing and spreading of the formulation over the entire surface of the wafer die at 500 rpm for 30 seconds, followed by a final spin-off step at 2,000 rpm for further 60 seconds. The acceleration of the spin speed was set to 500 rpm/s2. The soft bake and hard conditions of structured wafer dies was chosen similar or identical to those already mentioned for flat substrates.

All chemicals for synthesis described were purchased from Sigma Aldrich and used without further purification, unless differently mentioned elsewhere.

### Part A Single Metal Type Polyoxometalates

### Example 1

### Synthesis of Tetramethylammonium Decaniobate [(NMe₄)₆Nb₁₀O₂₈*6H₂O]

A reaction apparatus composed of a three-necked reaction flask equipped with a reflux condenser, glass thermometer and a magnetic stir bar was thoroughly flushed by constant stream of Ar. A conventional magnetic lab hotplate was used as heating source as well as a magnetically coupled stirrer. All followingly mentioned steps were performed under constant stirring of the reaction mixture. 689.743 g ethanol were added to the reaction flask and 87.793 g (0.276 mol) of niobium ethoxide were dissolved in the solvent. 50 g (0.276 mol) of tetramethylammonium hydroxide pentahydrate was added slowly to the solution. The temperature of the reaction mixture was raised to 90° C. and the mixture was allowed to react overnight. During the reaction, the solution turned into a suspension. After cooling down the reaction mixture, the precipitate was collected by filtration and washed by EtOH yielding a white powder which was dried at room temperature using a vacuum furnace. The product was subjected to elementary, ICP-OES and TG-analysis. TG-analysis yielded a residual mass of 70.24% w/w which was found to be in very good agreement with the expected value of 68.86% w/w. Elementary analysis of the product provided 15.2% w/w (14.94% w/w) for C, 4.4% w/w (4.39% w/w) for H and 4.5% w/w (4.35% w/w) for N, where theoretically expected values are provided as values in brackets. The content of niobium was found to be 46.0% w/w (48.14% w/w).

### Example 2

### Synthesis of Tetrabutylammonium Polyniobate

A reaction apparatus composed of a three-necked reaction flask equipped with a reflux condenser, glass thermometer and a magnetic stir bar was thoroughly flushed by constant stream of Ar. A conventional magnetic lab hotplate was used as heating source as well as a magnetically coupled stirrer. All followingly mentioned steps were performed under constant stirring of the reaction mixture. 59.25 g ethanol were added into the reaction flask and 9.456 g (0.030 mol) of niobium ethoxide were dissolved in the solvent. 7.784 g (0.010 mol) of tetrabutylammonium hydroxide (TBAH*30 H₂O) was added slowly and in portions to the solution. The temperature of the reaction mixture was raised to 90° C. and the mixture was allowed to react overnight. After cooling down the reaction mixture, the solvent was evaporated using a rotary evaporator yielding a yellow syrupus honey-like residue. The crude product was subjected to elementary, ICP-OES and TG-analysis. TG-analysis yielded a residual mass of 52.42% w/w. Elementary analysis of the product provided 32.9% w/w for C, 7.2% w/w for H. The content of niobium was found to be 35.0% w/w.

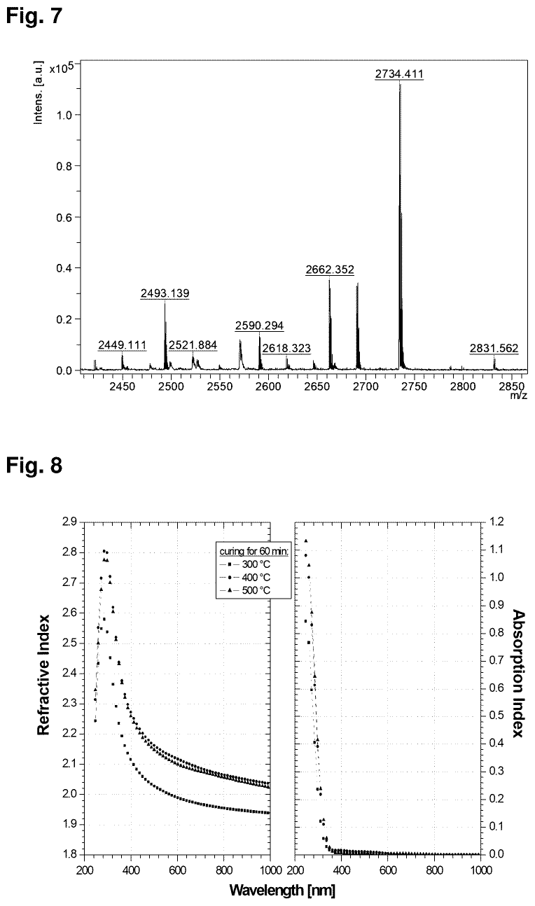

The product was furthermore subjected to MALDI-MS analysis (see FIG. 7). The peak at m/z at 2831.56 Da indicates an ion pair or cluster ion of hexakis (tetrabutylammonium) decaniobate [C₉₆H₂₁₆N₆O₂₈Nb₁₀]⁺. The peaks at m/z at 2590.29 Da suggest the loss of a tetrabutylammonium ligand, thus yielding the ion [C₈₀H₁₈₀N₅O₂₈Nb₁₀]⁺. The same is considered to be true for the peak at m/z at 2493.14 Da, which corresponds to the cluster ion of m/z 2734.41 Da less one tetrabutylammonium ligand.

### Example 3

The product obtained in Example 1 was dissolved in a solution composed of 1-methoxy-2-propanol (60% w/w) and water (40% w/w) to obtain a solution having a product concentration of 20% w/w. Coating was performed on quartz wafers according to the procedure as described in the general experimental part above. The coating speeds ranged from 1,500 rpm to 2,500 rpm with an interval of 500 rpm. After coating, the wafers were directly baked at 300° C., 400° C. and 500° C., respectively, for 5 minutes as well as for 60 minutes, respectively. Layer thickness and refractive indices of the coated and baked layers were determined by ellipsometry (see Table 1).

TABLE 1
Layer thickness of samples coated at 1,500 rpm, 2,000
rpm and 2,500 rpm, respectively [(*) top to down],
and refractive index of material according to Example
1 after application according to Example 3.

| Curing | | | |
|---|---|---|---|
| Temperature | Curing Time | Layer Thickness | Refractive Index |
| [° C.] | [min] | [nm] (*) | at 520 nm |
| 300 | 5 | 115 | 1.931 |
| | | 111 | |
| | | 103 | |
| 300 | 60 | 252 | 2.001 |
| | | 207 | |
| 400 | 5 | 207 | 2.073 |
| | | 191 | |
| | | 178 | |
| 400 | 60 | 206 | 2.081 |
| | | 211 | |
| | | 185 | |
| 500 | 5 | 203 | 2.094 |
| | | 212 | |
| | | 171 | |
| 500 | 60 | 227 | 2.111 |
| | | 205 | |

### Example 4

The product obtained in Example 2 was dissolved in 1-methoxy-2-propanol to obtain a solution with a formal concentration of 20% w/w. Coating was performed on quartz wafers according to the procedure as described in the general experimental part above. The coating speeds ranged from 1,500 rpm to 2,500 rpm with an interval of 500 rpm. After coating, the wafers were directly baked at 300° C., 400° C. and 500° C., respectively, for 5 minutes as well as for 60 minutes, respectively. Layer thickness, refractive index and absorption index of the coated and baked layers were determined by ellipsometry (see Table 2 and FIG. 8).

TABLE 2
Layer thickness of samples coated at 1,500 rpm, 2,000
rpm and 2,500 rpm, respectively [(*) top to down],
and refractive index of material according to Example
2 after application according to Example 4.

| Curing | | | |
|---|---|---|---|
| Temperature | Curing Time | Layer Thickness | Refractive Index |
| [° C.] | [min] | [nm] (*) | at 520 nm |
| 300 | 5 | 262 | 1.85 |
| | | 222 | |
| | | 213 | |
| 300 | 60 | 190 | 2.02 |
| | | 173 | |
| | | 169 | |
| 400 | 5 | 164 | 2.14 |
| | | 151 | |
| | | 144 | |
| 400 | 60 | 161 | 2.15 |
| | | 138 | |
| | | 130 | |
| 500 | 5 | 149 | 2.17 |
| | | 143 | |
| | | 129 | |
| 500 | 60 | 158 | 2.14 |
| | | 144 | |
| | | 136 | |

### Example 5

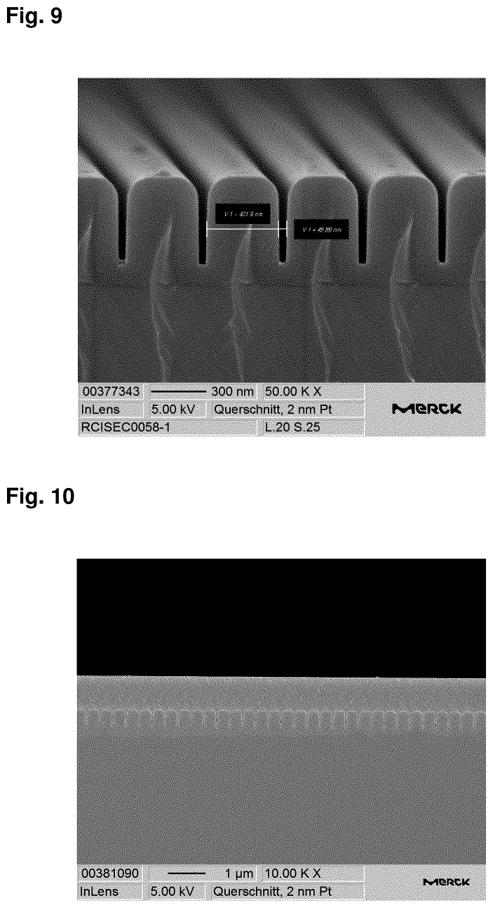

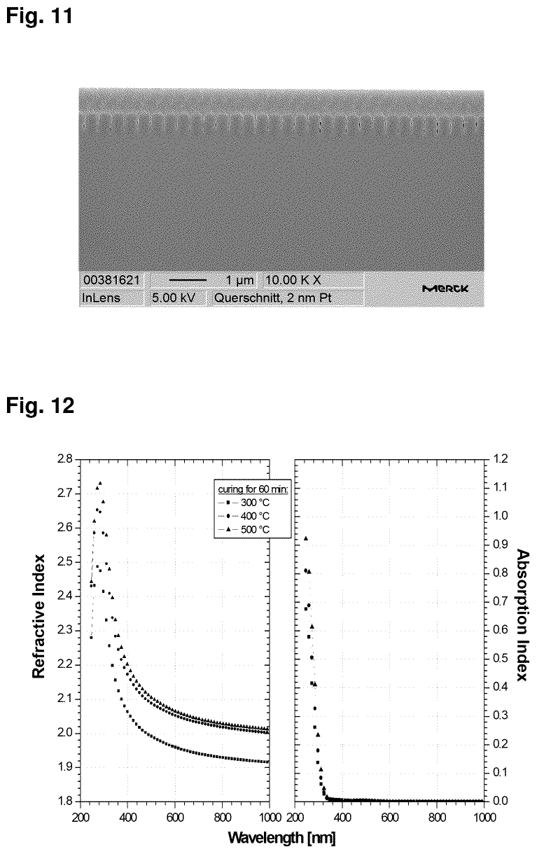

The product obtained in Example 2 was dissolved in 1-methoxy-2-propanol to obtain a solution with a formal concentration of 20% w/w. Squared silicon wafer dies with an edge length of 1.5 cm to 2.5 cm were used as substrate and coated with the aforementioned mixture. Each die comprised an array of different structures, mostly trenches of different opening widths where each array had a squared footprint with an edge length of about 0.5 cm. The depth of the trenches was constant, and their pitch was variable depending on the opening width of the trenches (see FIG. 9). The arrays were aligned so that the trenches were either parallel or perpendicular to each other. 0.5 ml of the coating mixture was deposited onto the die and allowed to spread for about one minute, followed by coating the dies at 500 rpm for 30 seconds as well as at 2,000 rpm for further 30 seconds. Then, the dies were pre-baked at 60° C. for 60 minutes to remove the residual solvent. As a next step, the dies were baked at 200° C. for 5 minutes. Coated dies were subjected to SEM cross-sectional analysis after the trench arrays were cleaved perpendicular to the running direction of the trenches. Cleaved parts were coated with a 2 nm thick Pt layer by sputtering. From the SEM cross-sections it can be seen that trenches were almost completely filled after pre-baking conducted at 60° C. (see FIG. 10). After baking at 200° C. (see FIG. 11), the trenches were still filled by the coated and baked metal oxide material.

### Example 6

### Tetrabutylammonium Polyniobate+Lanthanum Methoxy Ethoxide

The product obtained in Example 2 was dissolved in 1-methoxy-2-propanol to obtain a solution with a formal concentration of 20% w/w. To 4.020 g of this solution, 2.28 g of lanthanum methoxy ethoxide in methoxy ethanol (supplier: abcr), 3.69 g of 1-methoxy-2-propanol and 1 g of glacial acetic acid were added and stirred thoroughly yielding an oxide mixture with a nominal oxide content of 81.3% n/n of Nb₂O₅ and 17.7% n/n of La₂O₃. Coating was performed on quartz wafers according to the procedure as described in the general experimental part above. The coating speeds ranged from 1,500 rpm to 2,500 rpm with an interval of 500 rpm. After coating, the wafers were baked directly at 300° C., 400° C. and 500° C., respectively, for 5 minutes as well as for 60 minutes, respectively. Layer thickness, refractive index and absorption index of the coated and baked layers were determined by ellipsometry (see Table 3 and FIG. 12).

TABLE 3
Layer thickness of samples coated at 1,500 rpm, 2,000 rpm and
2,500 rpm, respectively [(*) top to down], and refractive
index of material according to Example 2 doped with lanthanum
oxide precursor after application according to Example 6.

| Curing | | | |
|---|---|---|---|
| Temperature | Curing Time | Layer Thickness | Refractive Index |
| [° C.] | [min] | [nm] (*) | at 520 nm |
| 300 | 5 | 71 | 1.924 |
| | | 55 | |
| | | 51 | |
| 300 | 60 | 61 | 1.984 |
| | | 50 | |
| | | 43 | |
| 400 | 5 | 52 | 2.067 |
| | | 45 | |
| | | 43 | |
| 400 | 60 | 59 | 2.079 |
| | | 45 | |
| | | 38 | |
| 500 | 5 | 47 | 2.101 |
| | | 40 | |
| | | 37 | |
| 500 | 60 | 52 | 2.095 |
| | | 41 | |
| | | 35 | |

### Example 7

### Tetrabutylammonium Polyniobate+Lanthanum Methoxy Ethoxide

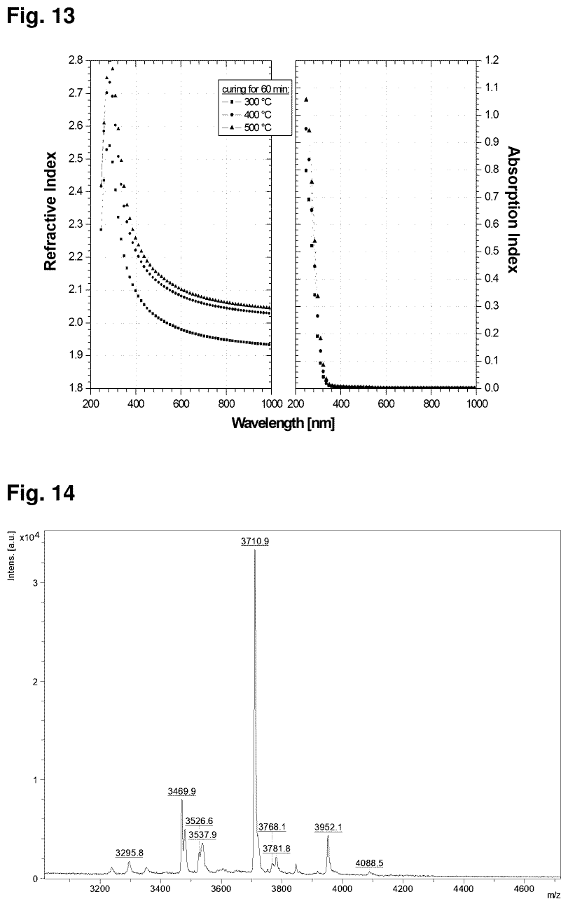

The product obtained in Example 2 was dissolved in 1-methoxy-2-propanol to obtain a solution with a formal concentration of 20% w/w. To 4.826 g of this solution, 1.173 g of lanthanum methoxy ethoxide in methoxy ethanol (supplier: abcr), 4 g of 1-methoxy-2-propanol and 1.5 g of glacial acetic acid were added and stirred thoroughly yielding an oxide mixture with a nominal oxide content of 91.6% n/n of Nb₂O₅ and 8.4% n/n of La₂O₃. Coating was performed on quartz wafers according to the procedure as described in the general experimental part above. The coating speeds ranged from 1,500 rpm to 2,500 rpm with an interval of 500 rpm. After coating, the wafers were baked directly at 300° C., 400° C. and 500° C., respectively, for 5 minutes as well as for 60 minutes, respectively. Layer thickness, refractive index and absorption index of the coated and baked layers were determined by ellipsometry (see Table 4 and FIG. 13).

TABLE 4
Layer thickness of samples coated at 1,500 rpm, 2,000 rpm and
2,500 rpm, respectively [(*) top to down], and refractive
index of material according to Example 2 doped with lanthanum
oxide precursor after application according to Example 7.

| Curing | | | |
|---|---|---|---|
| Temperature | Curing Time | Layer Thickness | Refractive Index |
| [° C.] | [min] | [nm] (*) | at 520 nm |
| 300 | 5 | 82 | 1.913 |
| | | 69 | |
| | | 63 | |
| 300 | 60 | 75 | 2.006 |
| | | 57 | |
| | | 50 | |
| 400 | 5 | 61 | 2.010 |
| | | 50 | |
| | | 45 | |
| 400 | 60 | 60 | 2.113 |
| | | 48 | |
| | | 43 | |
| 500 | 5 | 52 | 2.136 |
| | | 43 | |
| | | 38 | |
| 500 | 60 | 55 | 2.135 |
| | | 47 | |
| | | 44 | |

### Example 8

### Synthesis of Tetrabutylammonium Polytantalate

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 706.16 g acetonitrile were added into the reaction flask and 9.581 g (0.012 mol) of tetrabutylammonium hydroxide (TBAH*30 H₂O) and 2.661 g of water were dissolved in the solvent. 15 g (0.037 mol) of tantalum ethoxide were added dropwise to the solution and the mixture was allowed to stir overnight. After filtration via a 1 μm filter, the solvent was evaporated using a rotary evaporator to yield a syrupus honey-like residue. A minor fraction of the resin was withdrawn and subjected to further analysis, as e. g. elementary analysis. Elementary analysis of the product provided 23.2% w/w for C, 4.7% w/w for H and 3.2% w/w for N. The content of tantalum was found to be 51% w/w. The major fraction was dissolved in 1-methoxy-2-propanol to obtain a solution with a nominal concentration of 50% w/w. Upon dissolution, the mixture became slightly turbid. In the crude product still remaining nanoscaled particles were removed by centrifuge treatment allowing the dispersion to be treated twice at a rotation speed of 6,000 rpm for 60 min each. The supernatant was either used for further analysis or for application experiments. TG-Analysis of the solution yielded a residual mass of 36.72% w/w, thus 18.36% w/w Ta₂O₅ under the assumption of complete decombustion and conversion of polytantalate in air.

The solution was furthermore subjected to MALDI-MS analysis (see FIG. 14). The peak at m/z at 3710.9 Da indicates an ion pair or cluster ion of hexakis (tetrabutylammonium) decatantalate [C₉₆H₂₁₆N₆O₂₈Ta₁₀]⁺. The peaks at m/z at 3952.1 Da and 3469.9 Da may indicate either the addition or subtraction of a tetrabutylammonium ligand, thus [C₁₁₂H₂₅₂N₇O₂₈Ta₁₀]⁺ or [C₈₀H₁₈₀N₅O₂₈ Ta₁₀]⁺, respectively.

### Example 9

The product obtained in Example 8 was dissolved in 1-methoxy-2-propanol to obtain a solution with a formal concentration of 20% w/w. Coating was performed on quartz wafers according to the procedure as described in the general experimental part above. The coating speeds ranged from 1,000 rpm to 2,500 rpm with an interval of 500 rpm. After coating, the wafers were directly baked at 300° C., 400° C. and 500° C., respectively, for 60 minutes. Layer thickness and refractive index of the coated and baked layers were determined by ellipsometry (see Table 5).

TABLE 5
Layer thickness of samples coated at 1,000 rpm, 2,000
rpm and 2,500 rpm, respectively [(*) top to down],
and refractive index of material according to Example
8 after application according to Example 9.

| Curing | | | |
|---|---|---|---|
| Temperature | Curing Time | Layer Thickness | Refractive Index |
| [° C.] | [min] | [nm] (*) | at 520 nm |
| 300 | 60 | 178 | 1.897 |
| | | 147 | |
| | | 130 | |
| 400 | 60 | 163 | 1.979 |
| | | 127 | |
| | | 112 | |
| 500 | 60 | 146 | 2.043 |
| | | 113 | |
| | | 98 | |

### Example 10

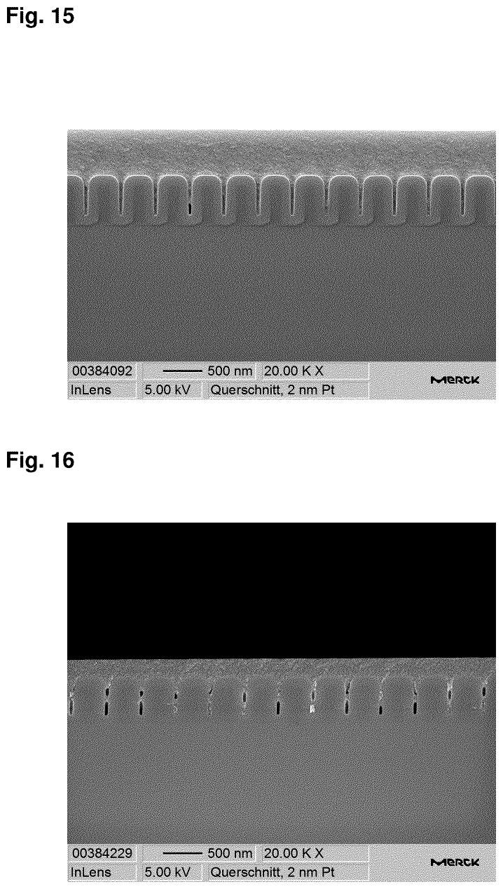

The product obtained in Example 8 was dissolved in 1-methoxy-2-propanol to obtain a solution with a formal concentration of 20% w/w. Wafer dies comprising structures as already described Example 5 were used and coated. Coating conditions and substrate preparation were identical to those already described in Example 5. Pre-baking of the layers was conducted at 60° C. for 60 min, followed by baking at 200° C. for 5 min including a temperature ramping phase between plateau temperatures of pre-baking and baking. Temperature ramping from 60° C. to 200° C. was allowed to take place for 20 min, thus providing a nominal heating rate of 7 K/min. From the SEM cross-sections it can be seen that trenches were almost completely filled after pre-baking conducted at 60° C. (see FIG. 15). After ramping the temperature from pre-baking to baking temperature at 200° C. (see FIG. 16), the trenches were still partly filled by the coated and baked metal oxide material.

### Part B Dual Metal Type Polyoxometalates (Mixed Metal Centers)

### Example 11

Synthesis of mixed tetrabutylammonium poly (niobate-tantalate) with nominal composition of 50% n/n Nb₂O₅ and 50% n/n Ta₂O₅

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 29.625 g of ethanol were added into the reaction flask and 4.773 g (0.015 mol) of niobium ethoxide as well as 6.094 g (0.015 mol) of tantalum ethoxide were added to it. Subsequently, 7.784 g (0.010 mol) of tetrabutylammonium hydroxide (TBAH*30 H₂O) was added to the mixture. The mixture was allowed to reflux overnight under stirring. Then, the solvent was evaporated using a rotary evaporator to yield a syrupus honey-like, highly viscous residue. Minor fractions of the resin were withdrawn and subjected to analysis, as e. g. elementary and thermogravimetric analysis. Elementary analysis of the product provided 24.2% w/w for C, 5.2% w/w for H and 1.6% w/w for N. The niobium content was 16% w/w and the tantalum content was 30% w/w (both by ICP-OES). TG-analysis yielded a mass residual mass of 63.24% w/w.

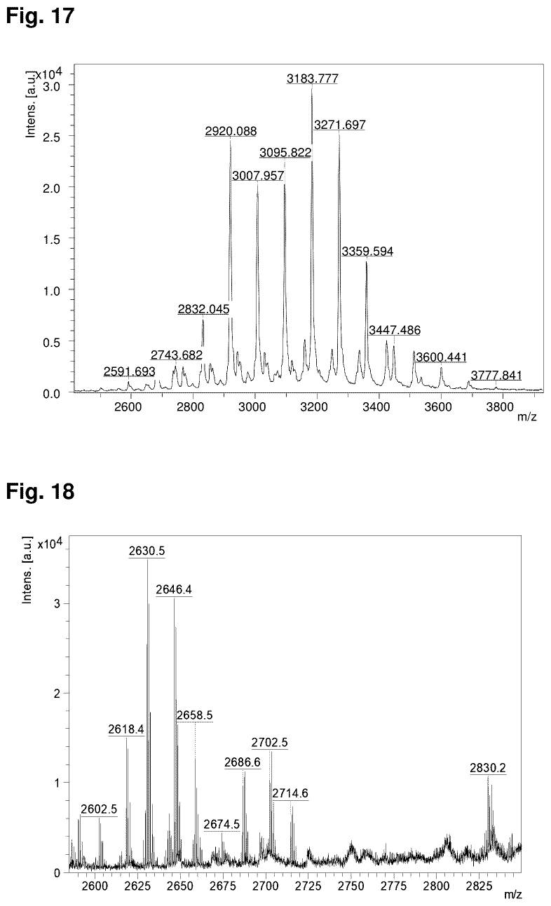

Further analysis by MALDI-MS (see FIG. 17) provided the data shown in Table 6.

TABLE 6
Mass peaks (m/z) of mixed tetrabutylammonium poly(niobate-tantalate)
cluster ions. The obtained material is composed of decametalate
cluster ions comprising different metal centers, thereby constituting
intermixed (deca)metalate ions. Hence, the mixed poly(niobate-
tantalate) does not represent a mixture of decaniobate and decatantalate
clusters being available next to each other. Other cluster
ions, e.g. such indicating the loss of one or more tetrabutylammonium
ligands from the cluster ion, which may be found in the spectrum
were not referred to.

| Peak (m/z) [Da] | Short | Assumed Sum Formula of Cluster Ions |
|---|---|---|
| 2832.05 | Nb₁₀ | C₉₆H₂₁₆N₆O₂₈Nb₁₀ |
| 2920.09 | Nb₉Ta₁ | C₉₆H₂₁₆N₆O₂₈Nb₉Ta |
| 3007.96 | Nb₈Ta₂ | C₉₆H₂₁₆N₆O₂₈Nb₈Ta₂ |
| 3095.82 | Nb₇Ta₃ | C₉₆H₂₁₆N₆O₂₈Nb₇Ta₃ |
| 3183.78 | Nb₆Ta₄ | C₉₆H₂₁₆N₆O₂₈Nb₆Ta₄ |
| 3271.70 | Nb₅Ta₅ | C₉₆H₂₁₆N₆O₂₈Nb₅Ta₅ |
| 3359.59 | Nb₄Ta₆ | C₉₆H₂₁₆N₆O₂₈Nb₄Ta₆ |
| 3447.49 | Nb₃Ta₇ | C₉₆H₂₁₆N₆O₂₈Nb₃Ta₇ |

### Example 12

The product obtained in Example 11 was dissolved in 1-methoxy-2-propanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes as well as 60 minutes. Layer thickness and refractive index of the coated and baked layers were determined by ellipsometry (see Table 7).

TABLE 7
Layer thickness of samples coated at 1,000 rpm, 2,000
rpm and 3,000 rpm, respectively [(*) top to down],
and refractive index of material according to Example
11 after application according to Example 12.

| Curing | | | |
|---|---|---|---|
| Temperature | Curing Time | Layer Thickness | Refractive Index |
| [° C.] | [min] | [nm] (*) | at 520 nm |
| 300 | 5 | 206 | 1.863 |
| | | 150 | |
| | | 142 | |
| 300 | 60 | 211 | 1.940 |
| | | 126 | |
| | | 139 | |
| 400 | 5 | 163 | 2.013 |
| | | 127 | |
| | | 112 | |
| 400 | 60 | 174 | 2.043 |
| | | 106 | |
| | | 97 | |
| 500 | 5 | 160 | 2.094 |
| | | 113 | |
| | | 98 | |
| 500 | 60 | 167 | 2.055 |
| | | 109 | |
| | | 93 | |

### Example 13

Synthesis of mixed tetrabutylammonium poly (niobate-titanate) with nominal composition of 71% n/n Nb₂O₅ and 29% n/n TiO₂ and metal ion to base ratio of 3:1

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 95.16 g of ethanol were added into the reaction flask and 15.090 g (0.047 mol) of niobium ethoxide as well as 2.800 g (0.0099 mol) of titanium isopropoxide were added to it. Subsequently, 15.070 g (0.019 mol) of tetrabutylammonium hydroxide (TBAH*30 H₂O) was added to the mixture. The mixture was allowed to reflux overnight under stirring. Then, the solvent was evaporated using a rotary evaporator to yield a slightly foamy, creamy-yellowish solid residue. The residue was subjected to thermogravimetric and elementary analysis. Elementary analysis of the product provided 33.8% w/w for C, 6.7% w/w for H and 2.0% w/w for N. The niobium content was 30% w/w and the titanium content was 3.3% w/w (both by ICP-OES). TG-analysis yielded a mass residual mass of 51.30% w/w.

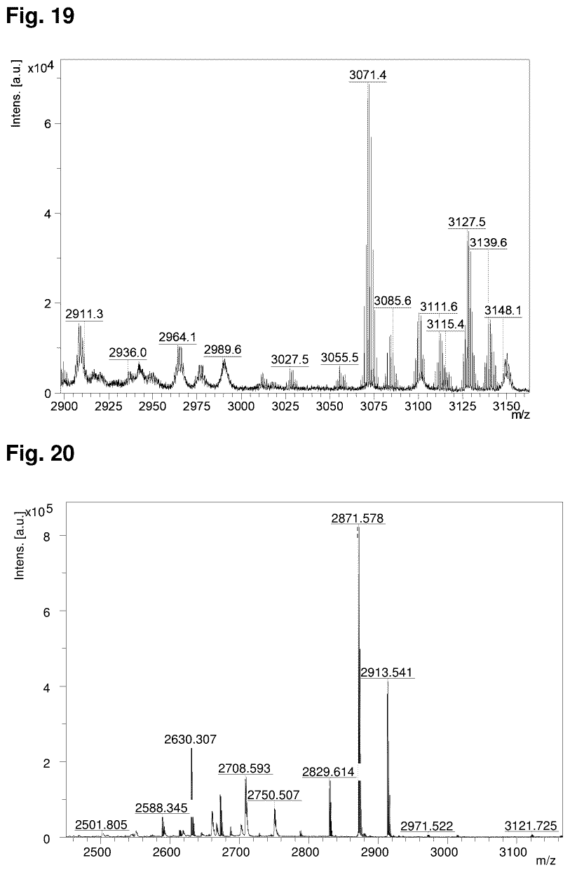

Further analysis was provided by MALDI-MS (see FIGS. 18 and 19).

FIG. 18: The peak at m/z at 2830 Da refers to the cluster ion [C₉₆H₂₁₆N₆O₂₈Nb₁₀]⁺. From the isotope pattern of the peak at m/z at 2646 Da, it can be concluded that species or cluster ion contains Ti.

FIG. 19: The same is true for the peaks at m/z at 3071 Da and 3127 Da; both peak show isotope patterns indicating the presence of Ti in the cluster ions. The peak at m/z>2900 Da refers to titanium-containing cluster ions in particular. Very pronounced cluster ions of this type, showing typical isotope pattern of titanium-containing ions, can be found at positions m/z at 3071 Da and 3127 Da. The cluster ion at m/z at 3027 Da seems to refer to a cluster ion in which one of the niobium metal centers is exchanged by titanium, thus forming the following cluster ion: [C₁₁₂H₂₅₂N₇O₂₈Nb₉Ti]⁺.

### Example 14

The product obtained in Example 13 was dissolved in 1-methoxy-2-propanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 8).

TABLE 8
Layer thickness of samples coated at 1,000 rpm, 2,000
rpm and 3,000 rpm, respectively [(*) top to down],
and refractive index of material according to Example
13 after application according to Example 14.

| Curing | | | |
|---|---|---|---|
| Temperature | Curing Time | Layer Thickness | Refractive Index |
| [° C.] | [min] | [nm] (*) | at 520 nm |
| 300 | 5 | 264 | 1.887 |
| | | 180 | |
| | | 142 | |
| 400 | 5 | 170 | 2.118 |
| | | 111 | |
| | | 102 | |
| 500 | 5 | 223 | 2.174 |
| | | 119 | |
| | | 112 | |

### Example 15

Synthesis of mixed tetrabutylammonium poly (niobate-titanate) with nominal composition of 71% n/n Nb₂O₅ and 29% n/n TiO₂ and metal ion to base ratio of 1.6:1

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 95.16 g of ethanol were added into the reaction flask and 15.15 g (0.048 mol) of niobium ethoxide as well as 2.800 g (0.0099 mol) of titanium isopropoxide were added to it. Subsequently, 29.32 g (0.037 mol) of tetrabutylammonium hydroxide (TBAH*30 H₂O) was added to the mixture. The mixture was allowed to reflux overnight under stirring. Then, the solvent was evaporated using a rotary evaporator to yield a slightly highly viscous creamy-yellowish resin. The residue was subjected to thermogravimetric and elementary analysis. Elementary analysis of the product provided 42.5% w/w for C, 8.4% w/w for H and 2.8% w/w for N. The niobium content was 24% w/w and the titanium content was 2.6% w/w (both by ICP-OES).

### Example 16

The product obtained in Example 15 was dissolved in 1-methoxy-2-propanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 9).

TABLE 9
Layer thickness of samples coated at 1,000 rpm, 2,000
rpm and 3,000 rpm, respectively [(*) top to down],
and refractive index of material according to Example
15 after application according to Example 16.

| Curing | | | |
|---|---|---|---|
| Temperature | Curing Time | Layer Thickness | Refractive Index |
| [° C.] | [min] | [nm] (*) | at 520 nm |
| 300 | 5 | 217 | 1.856 |
| | | 136 | |
| | | 125 | |
| 400 | 5 | 143 | 2.113 |
| | | 96 | |
| | | 87 | |
| 500 | 5 | 143 | 2.151 |
| | | 110 | |
| | | 100 | |

### Example 17

Synthesis of mixed tetrabutylammonium poly (niobate-vanadate) with nominal composition of 81% n/n Nb₂O₅ and 19% n/n V₂O₅

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 93.95 g of ethanol were added into the reaction flask and 15.19 g (0.048 mol) of niobium ethoxide as well as 5.81 g (0.011 mol) of vanadyl triisopropylate were added to it. Subsequently, 14.72 g (0.037 mol) of tetrabutylammonium hydroxide (TBAH*30 H₂O) was added to the mixture. The mixture was allowed to reflux overnight under stirring. Then, the solvent was evaporated using a rotary evaporator to yield an intensively dark green colored, slightly foamy residue. The residue was subject to thermogravimetric and elementary analysis. Elementary analysis of the product provided 32.6% w/w for C, 6.4% w/w for H and 1.8% w/w for N. The niobium content was 27% w/w and the titanium content was 7.4% w/w (both by ICP-OES). TG-analysis yielded a mass residual mass of 43.53% w/w.

Further analysis by MALDI-MS (see FIG. 20) provided the data shown in Table 10.

TABLE 10
Mass peaks (m/z) of mixed tetrabutylammonium poly(niobate-vanadate)
cluster ions. The obtained material is composed of decametalate cluster
ions comprising different metal centers, thereby constituting intermixed
(deca)metalate ions. Hence, the mixed poly(niobate-vanadate) is not
composed of a mixture of e.g. decaniobate and decatantalate being
available next to each other. Besides, at m/z of 2871 Da and 2913
Da, cluster ions were found which suggest a formal exchange of niobium
by vanadium for which a mass difference of 42 Da may be attributed.
Normally, such an exchange is accompanied by a reduction of the mass
of (a given cluster) ion, as e.g. for the decaniobate ion. Here,
when taking the decaniobate-cluster ion, a formal increase of the
mass of the cluster ion of 42 Da was recorded.

| Peak (m/z) [Da] | Short | Assumed Sum Formula of Cluster Ions |
|---|---|---|
| 2830 | Nb₁₀ | [C₉₆H₂₁₆N₆O₂₈Nb₁₀]⁺ |
| 2788 | Nb₉V₁ | [C₉₆H₂₁₆N₆O₂₈Nb₉V]⁺ |
| 2750 | Nb₈V₂ | [C₉₆H₂₁₆N₆O₂₈Nb₈V₂]⁺ |
| 2708 | Nb₇V₃ | [C₉₆H₂₁₆N₆O₂₈Nb₇V₃]⁺ |
| 2666 | Nb₆V₄ | [C₉₆H₂₁₆N₆O₂₈Nb₆V₄]⁺ |
| 2588 | Nb₁₀—NBu₄ | [C₈₀H₁₈₀N₅O₂₈Nb₁₀]+ |

### Example 18

The product obtained in Example 17 was dissolved in 1-methoxy-2-propanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 11).

TABLE 11
Layer thickness of samples coated at 1,000 rpm, 2,000
rpm and 3,000 rpm, respectively [(*) top to down],
and refractive index of material according to Example
17 after application according to Example 18.

| Curing | | | |
|---|---|---|---|
| Temperature | Curing Time | Layer Thickness | Refractive Index |
| [° C.] | [min] | [nm] (*) | at 520 nm |
| 300 | 5 | 189 | 2.097 |
| | | 151 | |
| | | 124 | |
| 400 | 5 | 191 | 2.164 |
| | | 131 | |
| | | 110 | |
| 500 | 5 | 226 | 2.057 |
| | | 174 | |
| | | 158 | |

### Example 19

Synthesis of mixed tetrabutylammonium poly (tantalate-vanadate) with nominal composition of 75% n/n Ta₂O₅ and 25% n/n V₂O₅

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 706.161 g of acetonitrile were added into the reaction flask and 29.916 g (0.037 mol) of tetrabutylammonium hydroxide (TBAH*30 H₂O) and 8.308 g of water were added and dissolved. Subsequently, 35.13 g of tantalum ethoxide (0.086 mol) and 7.039 g (0.029 mol) of vanadyl triisopropylate were added in a dropwise manner. After completion of the addition, the mixture was allowed to stir overnight. After filtering the reaction mixture using a 1 μm filter, the solvent was evaporated using a rotary evaporator. A minor fraction of the resin was withdrawn and subjected to thermogravimetric analysis yielding a residual mass of 63.74% w/w. The major fraction was dissolved in 1-methoxy-2-propanol to obtain a solution with a nominal concentration of 50% w/w. Upon dissolution, the mixture became slightly turbid. In the crude product still remaining nanoscaled particles were removed by centrifuge treatment allowing the dispersion to be treated twice at a rotation speed of 6,000 rpm for 60 min each. The supernatant was used for application experiments.

### Example 20

The product obtained in Example 19 was further diluted with n-butanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 12).

TABLE 12
Layer thickness of samples coated at 1,000 rpm, 2,000
rpm and 3,000 rpm, respectively [(*) top to down],
and refractive index of material according to Example
19 after application according to Example 20.

| Curing | | | |
|---|---|---|---|
| Temperature | Curing Time | Layer Thickness | Refractive Index |
| [° C.] | [min] | [nm] (*) | at 520 nm |
| 300 | 5 | 162 | 1.945 |
| | | 113 | |
| | | 97 | |
| 400 | 5 | 151 | 2.017 |
| | | 102 | |
| | | 91 | |
| 500 | 5 | 136 | 2.075 |
| | | 101 | |
| | | 89 | |

### Example 21

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 706.165 g of acetonitrile were added into the reaction flask and 29.917 g (0.037 mol) of tetrabutylammonium hydroxide (TBAH*30 H₂O) and 8.308 g of water were added and dissolved. Subsequently, 23.42 g of tantalum ethoxide (0.058 mol) and 14.078 g (0.058 mol) of vanadyl triisopropylate were added in a dropwise manner. After completion of the addition, the mixture was allowed to stir overnight. After filtering the reaction mixture using a 1 μm filter, the solvent was evaporated using a rotary evaporator. A minor fraction of the resin was withdrawn and subjected to thermogravimetric analysis yielding a residual mass of 61.81% w/w. The major fraction was dissolved in 1-methoxy-2-propanol to obtain a solution with a nominal concentration of 50% w/w. Upon dissolution, the mixture became slightly turbid. In the crude product still remaining nanoscaled particles were removed by centrifuge treatment allowing the dispersion to be treated twice at a rotation speed of 6,000 rpm for 60 min each. The supernatant was used for application experiments.

### Example 22

The product obtained in Example 21 was further diluted with n-butanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 13).

TABLE 13
Layer thickness of samples coated at 1,000 rpm, 2,000
rpm and 3,000 rpm, respectively [(*) top to down],
and refractive index of material according to Example
21 after application according to Example 22.

| Curing | | | |
|---|---|---|---|
| Temperature | Curing Time | Layer Thickness | Refractive Index |
| [° C.] | [min] | [nm] (*) | at 520 nm |
| 300 | 5 | 181 | 2.055 |
| | | 129 | |
| | | 116 | |
| 400 | 5 | 167 | 2.146 |
| | | 129 | |
| | | 97 | |
| 500 | 5 | 151 | 2.091 |
| | | 115 | |
| | | 103 | |

### Example 23

flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 481.152 g of acetonitrile were added into the reaction flask and 17.75 g (0.022 mol) of tetrabutylammonium hydroxide (TBAH*30 H₂O) and 7.923 g of water were added and dissolved. Subsequently, 25.05 g of tantalum ethoxide (0.062 mol) and 2.35 g (0.008 mol) of titanium isopropoxide were added in a dropwise manner. After completion of the addition, the mixture was allowed to stir overnight. After filtering the reaction mixture using a 1 μm filter, the filtrate still containing nanoscaled particles was subjected to centrifuge treatment allowing the dispersion to be treated twice at a rotation speed of 3,700 rpm for 30 min. The supernatant was treated in a rotary evaporator to remove the solvent yielding a highly viscous yellowish resin. The crude product was subjected to elementary and thermogravimetric analysis. Latter yielded a residual mass of 59.99% w/w. Elementary analysis of the product provided 26.4% w/w for C, 6.4% w/w fo

The product obtained in Example 23 was further diluted with 1-methoxy-2-propanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 14).

TABLE 14
Layer thickness of samples coated at 1,000 rpm, 2,000
rpm and 3,000 rpm, respectively [(*) top to down],
and refractive index of material according to Example
23 after application according to Example 24.

| Curing | | | |
|---|---|---|---|
| Temperature | Curing Time | Layer Thickness | Refractive Index |
| [° C.] | [min] | [nm] (*) | at 520 nm |
| 300 | 5 | 166 | 1.875 |
| | | 92 | |
| | | 95 | |
| 400 | 5 | 152 | 1.972 |
| | | 94 | |
| | | 83 | |
| 500 | 5 | 110 | 2.019 |
| | | 85 | |
| | | 76 | |

### Example 24

The product obtained in Example 23 was further diluted with 1-methoxy-2-propanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 14).

TABLE 14
Layer thickness of samples coated at 1,000 rpm, 2,000
rpm and 3,000 rpm, respectively [(*) top to down],
and refractive index of material according to Example
23 after application according to Example 24.

| Curing | | | |
|---|---|---|---|
| Temperature | Curing Time | Layer Thickness | Refractive Index |
| [° C.] | [min] | [nm] (*) | at 520 nm |
| 300 | 5 | 166 | 1.875 |
| | | 92 | |
| | | 95 | |
| 400 | 5 | 152 | 1.972 |
| | | 94 | |
| | | 83 | |
| 500 | 5 | 110 | 2.019 |
| | | 85 | |
| | | 76 | |

### Example 25

Synthesis of mixed tetrabutylammonium poly (tantalate-titanate) with nominal composition of 67% n/n Ta₂O₅ and 33% n/n TiO₂

A reaction apparatus composed of a three-necked reaction flask equipped with a reflux condenser, glass thermometer and a magnetic stir bar was thoroughly flushed by a constant stream of Ar. A conventional magnetic lab hotplate was used as heating source as well as a magnetically coupled stirrer. All followingly mentioned steps were performed under constant stirring of the reaction mixture. 705.828 g of acetonitrile were added into the reaction flask and 29.91 g (0.037 mol) of tetrabutylammonium hydroxide (TBAH*30 H₂O) and 8.3 g of water were added and dissolved. Subsequently, 24.3 g of tantalum ethoxide (0.060 mol) and 5.1 g (0.015 mol) of titanium isopropoxide were added in a dropwise manner. After completion of the addition, the mixture was allowed to stir overnight. After filtering the reaction mixture using a 1 μm filter, the filtrate still containing nanoscaled particles was subjected to centrifuge treatment allowing the dispersion to be treated twice at a rotation speed of 3,700 rpm for 30 min. The supernatant was treated in a rotary evaporator to remove the solvent yielding a highly viscous yellowish resin. The crude product was subjected to elementary and thermogravimetric analysis. Latter yielded a residual mass of 51.31% w/w. Elementary analysis of the product provided 33.2% w/w for C, 6.7% w/w for H and 2.6% w/w for N. The tantalum content was 38% w/w and the titanium content was 0.3% w/w (both by ICP-OES).

### Example 26

The product obtained in Example 23 was further diluted with 1-methoxy-2-propanol to obtain a solution with a formal concentration of 20% w/w. Coating was performed on quartz wafers according to the procedure as described in the general experimental part above. The coating speeds ranged from 1,000 rpm to 3,000 rpm with an interval of 1,000 rpm. After coating, the wafers were directly baked at 300° C., 400° C. and 500° C., respectively, for 5 minutes. Layer thickness and refractive index of the coated and baked layers were determined by ellipsometry (see Table 15).

TABLE 15
Layer thickness of samples coated at 1,000 rpm, 2,000
rpm and 3,000 rpm, respectively [(*) top to down],
and refractive index of material according to Example
25 after application according to Example 26.

| Curing | | | |
|---|---|---|---|
| Temperature | Curing Time | Layer Thickness | Refractive Index |
| [° C.] | [min] | [nm] (*) | at 520 nm |
| 300 | 5 | 130 | 1.856 |
| | | 91 | |
| | | 81 | |
| 400 | 5 | 109 | 1.960 |
| | | 78 | |
| | | 66 | |
| 500 | 5 | 93 | 2.026 |
| | | 65 | |
| | | 57 | |

The above examples show that the technical objects of the present invention are achieved.

### LIST OF REFERENCE SIGNS

1 Material 02 with RI 02
2 Material 01 with RI 01
3 Substrate (e.g. glass)
4 Diffraction of incident light represented by broad arrow
5 Total internal reflection of light (TIR)
6 Waveguide
7 Structured layer stack with gaps (trenches)
8 Substrate (e.g. glass or silicon)
9 Overburden of material (e.g. high refractive index material or high etch resistant material)
10 Material (e.g. high refractive index material or high etch resistant material) providing gap fill
11 Voids
12 Formulation (e.g. ink) of high refractive index material (e.g. metal oxide precursor)
13 High refractive index material (e.g. metal oxide) providing gap fill with optional concave geometry
14 Overburden layer (optional)
15 Energy

1. A polyoxometalate compound containing a polyoxometalate cluster, wherein the polyoxometalate cluster comprises between two and three Group 5 elements.

2. The polyoxometalate compound according to claim 1, wherein the Group 5 elements are selected from the group consisting of V, Nb and Ta.

3. The polyoxometalate compound according to claim 1, wherein the polyoxometalate cluster further comprises one or more Group 4 elements selected from the group consisting of Ti, Zr and Hf.

4. The polyoxometalate compound according to claim 1, wherein the polyoxometalate cluster is represented by Formula (1):
[M¹ₓ₁M²ₓ₂O_{y}]^{m} Formula (1)
wherein:
M¹ is a mixture of two or three Group 5 elements selected from the group consisting of V, Nb and Ta;
M² is one or a mixture of more Group 4 elements selected from the group consisting of Ti, Zr and Hf;
O is oxygen;
x1 is an integer from 3 to 40;
x2 is an integer from 0 to 40;
y is an integer from 8 to 160; and
m represents the total charge of the polyoxometalate cluster.

5. The polyoxometalate compound according to claim 4, wherein the polyoxometalate cluster is represented by Formula (1):
[M¹ₓ₁M²ₓ₂O_{y}]^{m} Formula (1)
wherein:
M¹ is a mixture selected from the group consisting of V and Nb, V and Ta, Nb and Ta, or V, and Nb and Ta;
M² is Ti, Zr or Hf;
O is oxygen;
x1 is an integer from 3 to 40;
x2 is an integer from 0 to 40;
wherein x1+x2=3 to 40;
y is an integer from 8 to 160; and
m represents the total charge of the polyoxometalate cluster, wherein m=S1*x1+S2*x2−2*y, wherein S1 is 5, and S2 is 4.

6. The polyoxometalate compound according to claim 1, further comprising one or more cations independently from each other selected from the group consisting of H⁺, Li⁺, Na⁺, K⁺, Rb⁺, Cs⁺, NH₄₋ₐRₐ⁺, Mg²⁺, Ca²⁺, Sr²⁺ and Ba²⁺,
wherein R is an organic group; and
a is an integer from 0 to 4.

7. A formulation for preparing an optical metal oxide layer, wherein the formulation comprises:
(i) a polyoxometalate compound containing a polyoxometalate cluster, wherein the polyoxometalate cluster comprises one, two or three Group 5 elements selected from the group consisting of V, Nb and Ta; and
(ii) one or more formulation media.

8. The formulation according to claim 7, wherein the polyoxometalate cluster further comprises one or more Group 4 elements selected from the group consisting of Ti, Zr and Hf.

9. The formulation according to claim 7, wherein the polyoxometalate cluster is represented by Formula (1):
[M¹ₓ₁M²ₓ₂O_{y}]^{m} Formula (1)
wherein:
M¹ is one or a mixture of two or three Group 5 elements selected from the group consisting of V, Nb and Ta;
M² is one or a mixture of more Group 4 elements selected from the group consisting of Ti, Zr and Hf;
O is oxygen;
x1 is an integer from 3 to 40;
x2 is an integer from 0 to 40;
y is an integer from 8 to 160; and
m represents the total charge of the polyoxometalate cluster.

10. The formulation according to claim 9, wherein the polyoxometalate cluster is represented by Formula (1):
[M¹ₓ₁M²ₓ₂O_{y}]^{m} Formula (1)
wherein:
M¹ is one or a mixture of two or three Group 5 elements selected from the group consisting of V, Nb and Ta;
M² is selected from the group consisting of Ti, Zr and Hf;
O is oxygen;
x1 is an integer from 3 to 40;
x2 is an integer from 0 to 40;
wherein x1+x2=3 to 40;
y is an integer from 8 to 160; and
m represents the total charge of the polyoxometalate cluster, wherein m=S1*x1+S2*x2−2*y, wherein S1 is 5, and S2 is 4.

11. The formulation according to claim 7, wherein the polyoxometalate compound further comprises one or more cations independently from each other selected from the group consisting of H⁺, Li⁺, Na⁺, K⁺, Rb⁺, Cs⁺, NH₄₋ₐRₐ⁺, Mg²⁺, Ca²⁺, Sr²⁺ and Ba²⁺,
wherein R is an organic group; and
a is an integer from 0 to 4.

12. The formulation according to claim 7, wherein the content of the polyoxometalate compound in the formulation is in the range from 0.1% to 50% w/w, based on the total mass of the formulation.

13. The formulation according to claim 7, wherein the one or more formulation media are solution media and/or dispersion media.

14. The formulation according to claim 7, wherein the formulation further comprises (iii) one or more additives selected from surfactants, wetting and dispersion agents, adhesion promoters, and polymer matrices.

15. A method for preparing an optical metal oxide layer comprising the following steps (a) to (c):
(a) providing a formulation according to claim 7;
(b) applying the formulation to a surface of a substrate; and
(c) converting the formulation on the surface of the substrate to an optical metal oxide layer.

16. The method according to claim 15, wherein in step (b) the formulation is applied to a surface of a substrate by a deposition method.

17. The method according to claim 15, wherein in step (c) the formulation is converted on the surface of the substrate to an optical metal oxide layer by exposure to thermal treatment and/or irradiation treatment.

18. The method according to claim 15, wherein in step (c) the formulation is converted on the surface of the substrate to an optical metal oxide layer by pre-baking at a temperature from 40 to 150° C.; and then baking at a temperature from 150 to 600° C.

19. The method according to claim 15, wherein the substrate is a patterned substrate comprising topographical features on the surface thereof.

20. An optical device comprising an optical metal oxide layer, which is prepared by using the formulation according to claim 15.
